(19) United States
(12) Patent Application Publication
(10) Pub. No.: US 2012/0111554 A1
(43) Pub. Date: May 10, 2012

(54) Indoor Water Display and Air Improvement System

(75) Inventor: Jim Wilson, Weldon Spring, MO (US)

(73) Assignee: HUMIDIFALL, LLC, St. Charles, MO (US)

(21) Appl. No.: 13/318,049

(22) PCT Filed: May 3, 2010
(86) PCT No.: PCT/US10/33440

§ 371 Date: Jan. 10, 2012

Related U.S. Application Data
(60) Provisional application No. 61/174,771, filed on May 1, 2009.
(60) Provisional application No. 61/178,779, filed on May 15, 2009.

(51) Int. Cl. F24F 6/02; B05B 17/08; F24F 3/14; F24F 6/06; F24F 6/08

(52) U.S. Cl. 165/229; 236/44 A; 239/23

(57) ABSTRACT

An automated indoor water display system has a panel. A pump is operable to pump water from a reservoir to the panel in a manner that causes water to flow over at least a portion of the panel. The panel is held in a housing adapted to limit escape of moisture from the housing. The system can include a humidity control system operable to increase and/or decrease humidity in response to a humidity sensor. The system can include an ultraviolet sanitization system that limits microbial growth in the system. The system can also include a cleaning system that automatically exchanges water in the system with fresh water while the pump operates continuously during the exchange. The system can also include a fan positioned to direct airflow from the room containing the display unit toward the water flowing over the body to enhance removal of airborne contaminants from the air.

### FIELD OF INVENTION

The present invention is directed generally to systems and methods for controlling humidity and removing contaminants from indoor air, and more particularly to such systems and methods that involve exposing circulating water to the air in an interior space, such as by providing a decorative or aesthetically pleasing waterfall or other water display.

### BACKGROUND

Various decorative indoor fountains, waterfalls, and other water displays are known in the art. For instance, U.S. Pat. No. 6,024,292 discloses a decorative waterfall system that can be used to humidify an interior living space. The system includes a heater that heats the water when there is a desire to increase the humidity of the air. The resulting increase in the water temperature causes additional water vapor to be evaporated at the interface between the water and the ambient air. This adds humidity to the interior space containing the waterfall.

### SUMMARY

One aspect of the invention is a water display system. The system includes a panel having a top, a bottom, sides extending between the top and bottom, and a front surface extending between the sides. The system also has a reservoir for containing a supply of water and a pump operable to pump water from the reservoir to the panel in a manner that causes water to flow over at least a portion of the front surface of the panel. A housing holds the panel. The housing includes a sidewall extending along at least one side of the panel. The sidewall has a channel spaced from the panel. The channel has a cross sectional shape that tapers from a relatively wider width at an open side of the channel to a relatively narrower width at a closed side of the channel opposite the open side. A barrier is positioned to limit movement of water along the sidewall away from the panel. The barrier is secured in the channel and extends along at least a segment of the channel.

Another aspect of the invention is a water display system including a panel having a top, a bottom, sides extending between the top and bottom, and a front surface extending between the sides. The system includes a reservoir for containing a supply of water and a pump operable to pump water from the reservoir to the panel in a manner that causes water to flow over at least a portion of the front surface of the panel. A housing holds the panel. The housing includes a sidewall extending along at least one side of the panel. The sidewall has a channel spaced from the panel. The housing including a catch basin at the bottom of the panel. A barrier is positioned to limit movement of water along the sidewall away from the panel. The barrier is secured in the channel and extending along at least a segment of the channel. The system also includes a condensation guard positioned to limit condensation of vapor associated with water in the catch basin on the sidewall at a location on the opposite side of the barrier from the panel.

Still another aspect of the invention is a water display system including a body, a reservoir for containing a supply of water, and a pump operable to pump water from the reservoir to the body in a manner that causes water to flow over a surface of the body. The water is in contact with a gas as it flows over the surface of the body. The system also includes a humidity control system adapted to alter a humidity level of the gas by increasing a temperature of the water in the reservoir in response to a signal indicating the gas has a relatively lower humidity and decreasing the temperature of the water in the reservoir in response to a signal indicating the gas has a relatively higher humidity.

Another aspect of the invention is a water display system including a panel having, a top, a bottom, sides extending between the top and bottom, a front surface extending between the sides, and a back surface generally opposite the front surface. A housing holds the panel. The housing has an opening in registration with at least a portion of the front surface of the panel for viewing the panel and a back wall substantially covering the back surface of the panel. The system also includes a reservoir for containing a supply of water and a pump operable to pump water from the reservoir to the front surface of the panel to cause water to flow in a sheet along the front surface of the panel. The system also has backlighting system comprising one or more lights positioned to illuminate the back surface of the panel.

Yet another aspect of the invention is a water display system comprising a body and a fluidic system operable to cause water to flow over a surface of the body. The water circulation system includes a reservoir for containing a supply of water and a fluid circuit including at least one supply line for supplying water from the reservoir to the body and at least one return line for returning water from the body to the reservoir. A pump is operable to pump water from the reservoir through the fluid circuit to the body in a manner that causes the water to flow over said surface of the body. The system also includes a sanitizing system operable to limit microbial growth in the water circulation system.

Still another aspect of the invention is a water display system comprising a body and a fluidic system operable to cause water to flow over a surface of the body. The fluidic system includes a reservoir for containing a supply of water and a fluid circuit including at least one supply line for supplying water from the reservoir to the body and at least one return line for returning water from the body to the reservoir. A pump is operable to pump water from the reservoir through the through the fluid circuit to the body in a manner that causes the water to flow over the surface of the body. The system also has a cleaning system comprising a control system adapted to conduct at least two different cleaning protocols.

Another aspect of the invention is a water display system comprising a body and a fluidic system operable to cause water to flow over a surface of the body. The fluidic system includes a reservoir for containing a supply of water and a fluid circuit including at least one supply line for supplying water from the reservoir to the body and at least one return line for returning water from the body to the reservoir. A pump is operable to pump water from the reservoir through the through the fluid circuit to the body in a manner that causes the water to flow over said surface of the body. The system also includes a cleaning system adapted to (i) drain a portion of the water supply from the reservoir; (ii) add water to the reservoir to replenish the supply of water in the reservoir; and (iii) repeat the draining and adding at a frequency that achieves one hundred percent water exchange in a period of time ranging from about 1 hour to about 1 week. The cleaning system is operable to achieve one hundred percent water exchange while the pump operates continuously during the exchange.

Still another aspect of the invention is a water display system including a body, a reservoir for containing a supply of water, and a pump operable to pump water from the reservoir to the body in a manner that causes water to flow over a surface of the body. The water is in contact with a gas as it flows over the surface of the body. The system also includes a humidity sensor operable to monitor a humidity level of said gas and generate signals indicative of the humidity level. The system has a control system including a control panel operable to receive input from a user and display information about the water display system. The control system is adapted to receive said signals from the humidity sensor and increase the temperature of the water in the reservoir in response to a signal from the humidity sensor indicating the gas has a humidity lower than a minimum desired humidity and to decrease the temperature of the water in the reservoir in response to a signal from the humidity sensor indicating the gas has a humidity higher than a maximum desired humidity. The control system is adapted change at least one of the minimum desired humidity and the maximum desired humidity in response to an input received by the control panel from a user.

Yet another aspect of the invention is a water display system including a panel having a top and a front surface extending down from the top and a reservoir for containing a supply of water. A housing holds the panel. The housing includes a weir assembly having a channel for receiving the top of the panel. The channel is at least partially defined by a weir positioned to extend over an upper portion of the front surface of the panel when the top of the panel is in the channel. The weir assembly also has a trough adjacent the channel. A pump is operable to pump water from the reservoir to the trough. The weir assembly is constructed so overflow from the trough flows over the top of the panel and down along the front surface of the panel.

Still another aspect of the invention is a water display system including a panel having a top and front and back surfaces extending down from the top and a reservoir for containing a supply of water. A manifold is positioned above the top of the panel. The manifold has a plurality of outlets positioned to distribute water along the top of the panel. A pump is operable to pump water from the reservoir to the manifold. The system is constructed so water distributed to the top of the panel flows in sheets down the front and back surfaces of the panel.

Yet another aspect of the invention is an indoor air improvement system including a water display unit. The system includes a body, a reservoir for containing a supply of water, and a pump operable to pump water from the reservoir to the body in a manner that causes water to flow over at least a portion of the body. A housing holds the body. A fan positioned to direct air flow over the portion of the body over which water flows.

Another aspect of the invention is a water display system including a panel having a top, a bottom, sides extending between the top and bottom, and a front surface extending between the sides. The system also has a reservoir for containing a supply of water, a manifold having a plurality of openings distributed along a length of the manifold, and a pump operable to pump water from the reservoir to the manifold. Two or more pairs of brackets hold the top of the panel under the manifold. Each bracket pair includes first and second brackets. Each of the first and second brackets includes a support plate having a notched corner located so the first and second brackets can be positioned adjacent one another such that the notched corners together form a notch in the bottom of the bracket for receiving the top of the panel. The first bracket is mountable on a wall or other support structure independently of the second bracket.

Other objects and features will in part be apparent and in part pointed out hereinafter.

### BRIEF DESCRIPTION OF THE DRAWINGS

FIG. 1 is a perspective of one embodiment of a water display unit of a system of the present invention installed in a wall (portions of which are broken away);

FIG. 2 is a front elevation of the water display unit and wall of FIG. 1;

FIG. 3 is a perspective of an indoor air improvement system including the water display unit mounted in a wall;

FIG. 4 is a front elevation of the indoor air improvement system;

FIG. 5 is an exploded perspective of the water display unit;

FIG. 6 is a perspective of one embodiment of a water display unit housing;

FIG. 7 is a front elevation of the water display unit;

FIG. 8 is a horizontal section of the water display unit taken in a plane including line 8-8 on FIG. 7;

FIG. 9 is fragmentary section of the water display unit taken in a plane including line 9-9 on FIG. 7;

FIG. 10 is a fragmentary perspective of the lower portion of the water display unit sectioned as in FIG. 9;

FIG. 11 is a perspective of a bracket for supporting the bottom of a panel in the water display unit housing;

FIG. 12 is a fragmentary section the water display unit taken in a plane including line 12-12 on FIG. 7;

FIG. 13 is a fragmentary perspective of the upper portion of the water display unit sectioned as in FIG. 12;

FIG. 14 is an exploded perspective of the upper portion of the water display unit;

FIG. 15 is an enlarged fragment of the water display unit of FIG. 8;

FIG. 16 is a top plan view of a blank that can be used to make the water display unit housing;

FIG. 17 is a perspective of a reservoir and other components of a fluidic system for the indoor air improvement system;

FIG. 18 is a top plan view of the reservoir and other components of the fluidic system with a reservoir cover removed to show features contained in the reservoir;

FIG. 19 is schematic cross section of an ultraviolet sanitizer taken in a plane including line 19-19 on FIG. 17;

FIG. 20 is a schematic diagram of the indoor air improvement system;

FIG. 21 is a perspective of another embodiment of an indoor air improvement system;

FIG. 22 is a perspective of a water display unit of the system illustrated in FIG. 21;

FIG. 23 is a front elevation of the water display unit illustrated in FIG. 22;

FIG. 24 is an exploded perspective of the water display unit illustrated in FIGS. 22-23;

FIG. 25 is a fragmentary section of the water display unit taken in a plane including line 25-25 on FIG. 23;

FIG. 26 is a fragmentary section of the water display unit taken in a plane including line 26-26 on FIG. 23;

FIG. 27 is a perspective of another embodiment of an indoor air improvement system;

FIG. 28 is a perspective of a water display unit of the system illustrated in FIG. 27;

FIG. 29 is a front elevation of the water display unit illustrated in FIG. 28;

FIG. 30 is an exploded perspective of the water display unit illustrated in FIGS. 28 and 29; and

FIG. 31 is a fragmentary section of the water display unit taken in a plane including line 31-31 on FIG. 29.

Corresponding reference characters indicate corresponding parts throughout the drawings.

### DETAILED DESCRIPTION

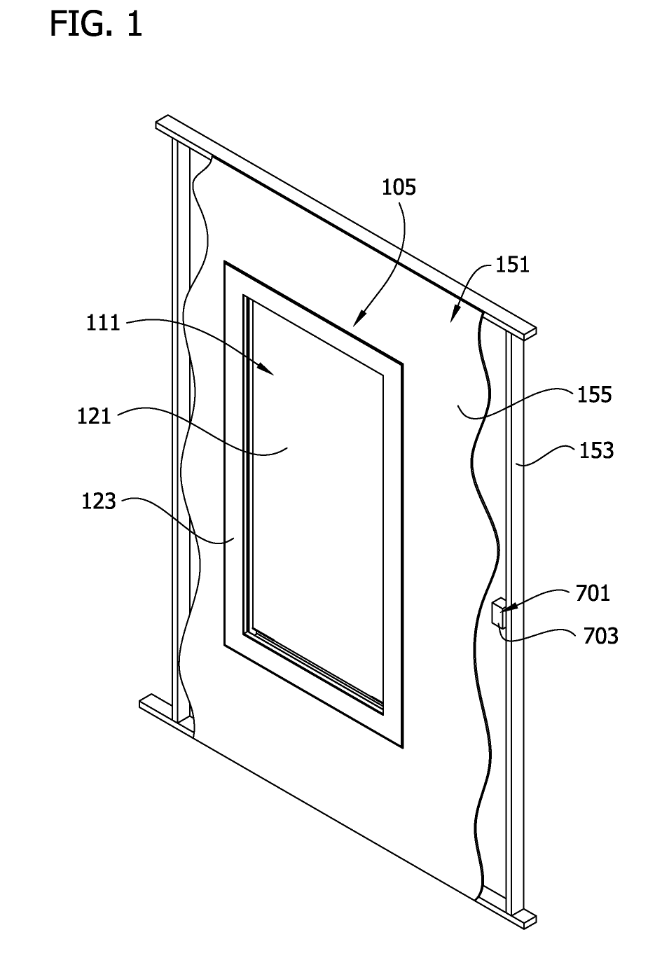

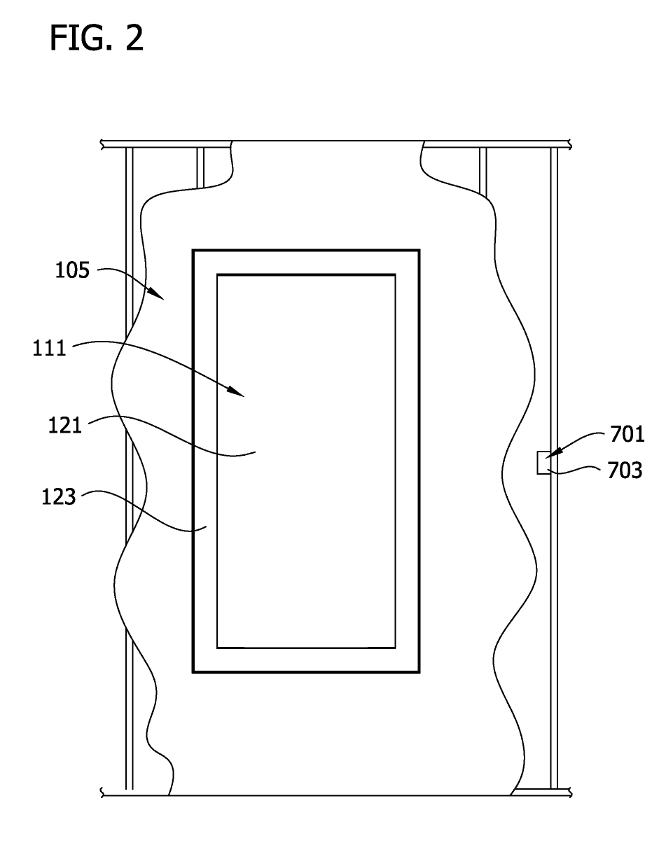

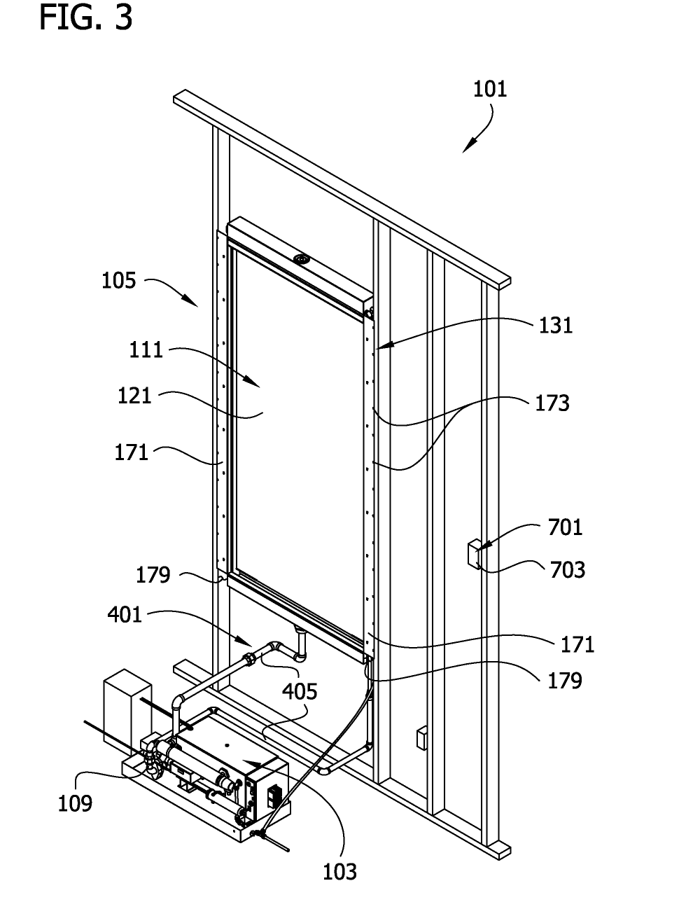

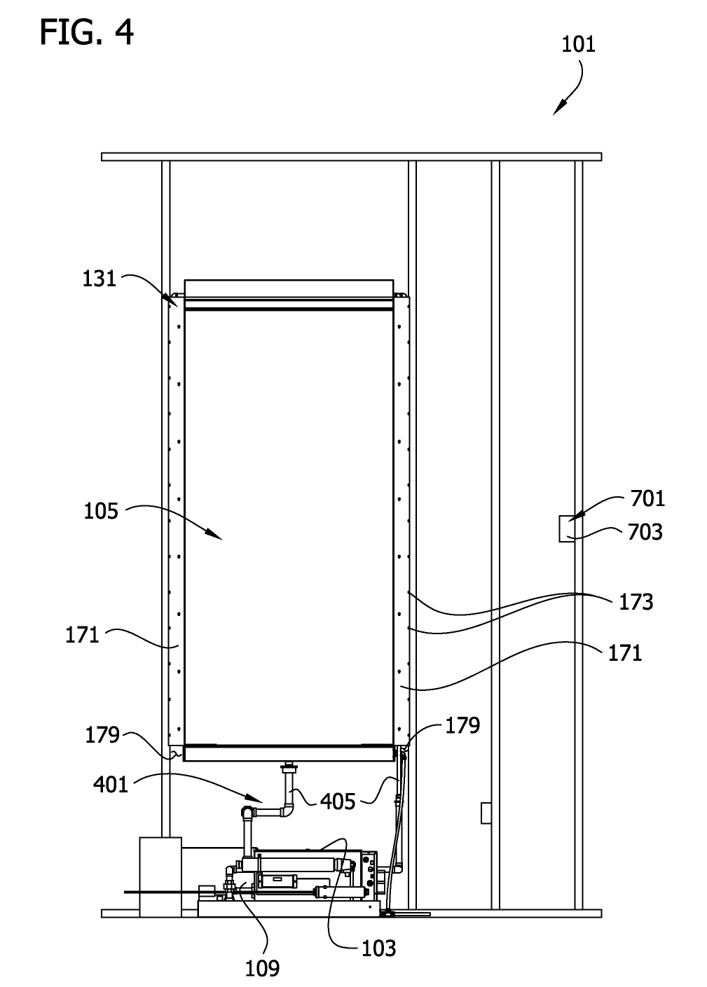

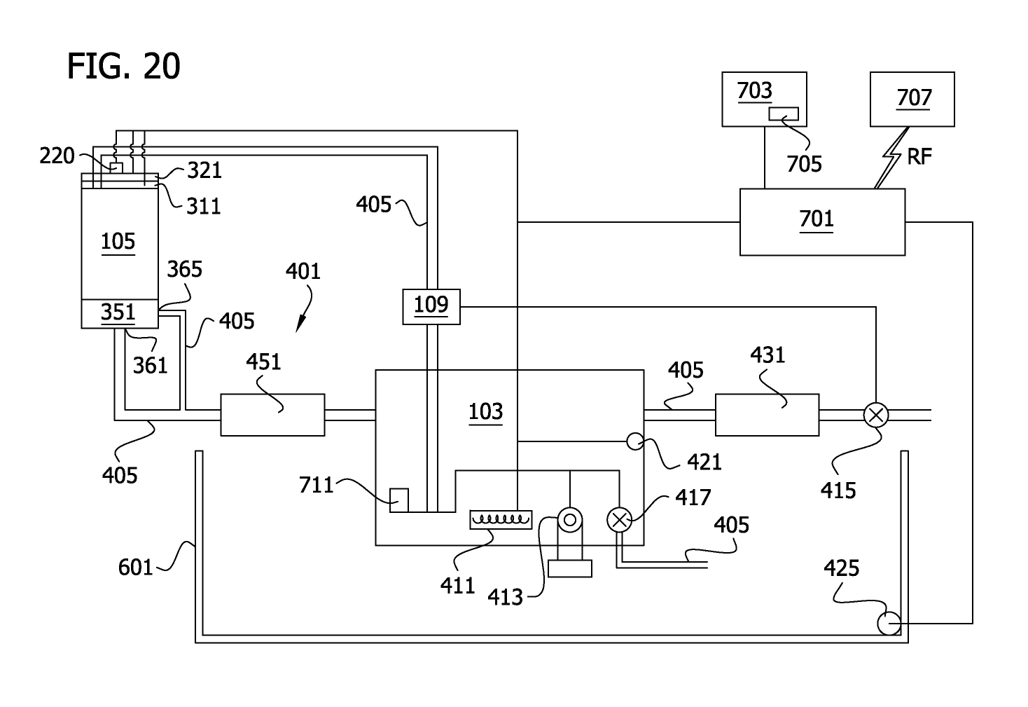

Referring to the drawings, FIGS. 1-2 illustrate an exemplary embodiment of a water display unit of the present invention, generally designated 105. FIGS. 3 and 4 illustrate one embodiment of an indoor air improvement system 101 including the water display unit 105. The system 101 includes a reservoir 103 for containing a supply of water (e.g., 5 gallons), the water display unit 105, and pump 109 operable to pump water from the reservoir to the water display unit in manner that results in water flowing over a body 111 (e.g., a sheet or panel) that is part of the display unit. The water display system 101 suitably includes an electronic control system 701 (See FIG. 20) that controls various aspects of the system, as described in more detail below. The control system 701 suitably includes one or more processors. The control system 701 is also suitably adapted to interface with a user and accept input from a user (e.g., via a control panel 703 mounted in proximity to the display unit 105) to adjust operation of the water display system 101.

Typically, the water display unit 105 displays the flowing water in an aesthetically pleasing manner such that the air improvement system 101 can also be considered a decorative system. The aesthetics of the display unit 105 can vary widely within the scope of the invention to suit a wide range of tastes and desires. Further, systems that are not decorative or otherwise aesthetically pleasing are considered to be within the scope of the invention. In FIGS. 1 and 2, the display unit 105 is a waterfall installed in a wall 151 (e.g., of a home or business). However, the display unit can vary widely in form within the scope of the invention. For example, the display unit may be a free-standing waterfall that is not associated with any wall or a different type of water display unit within the scope of the invention.

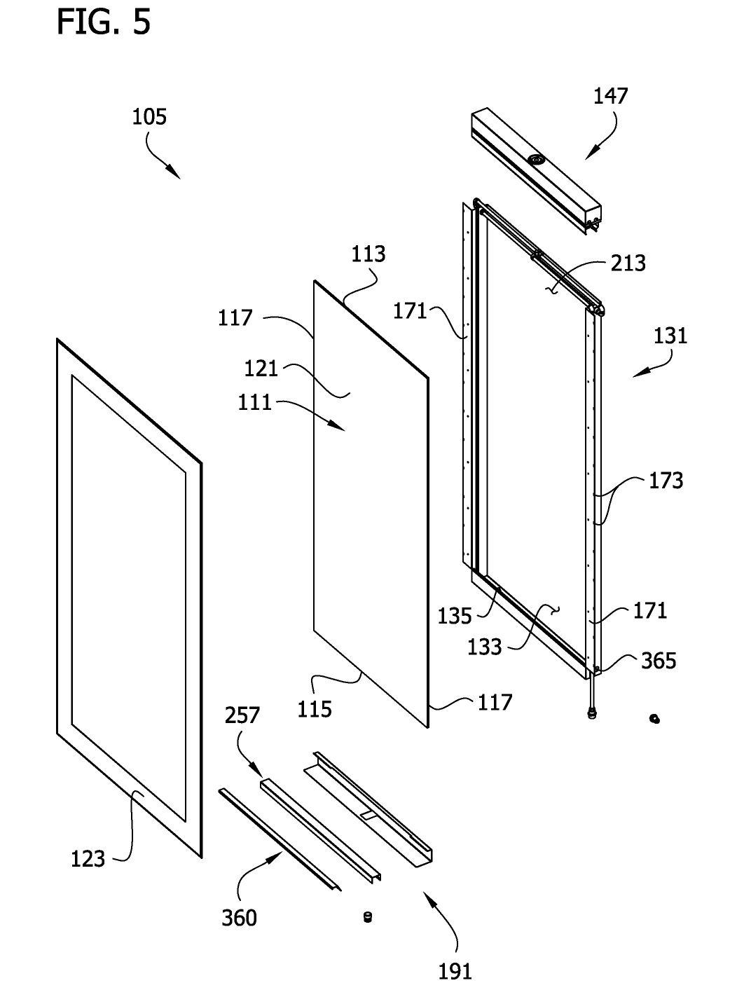

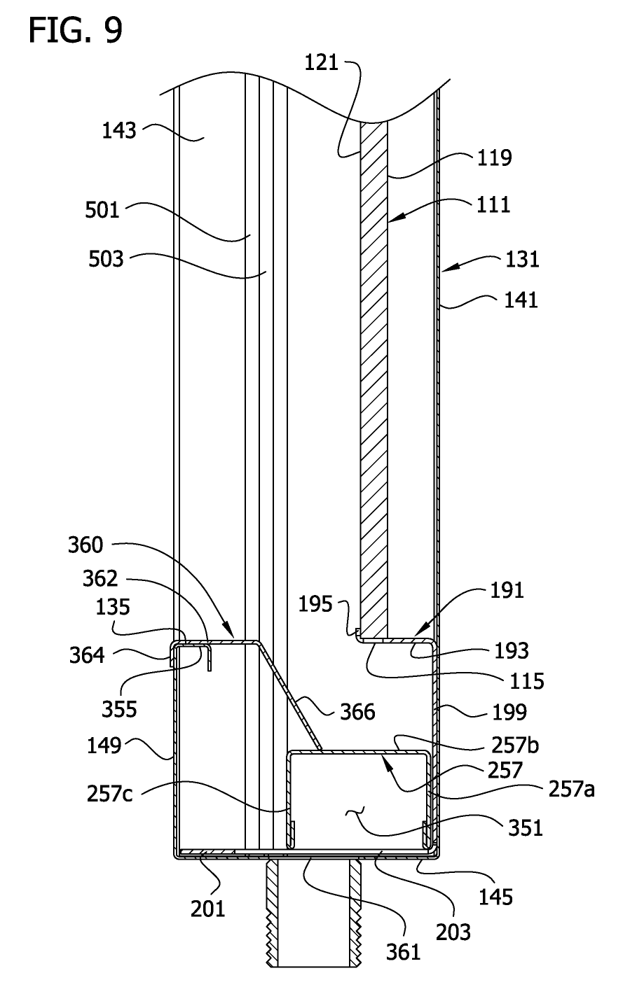

As illustrated in FIG. 5, the body 111 of the water display unit 105 is a panel 111 having: a top 113; a bottom 115; sides 117 extending between the top and bottom; a generally planar front surface 121 extending between the top, bottom, and extending between the sides; and a back surface 119 (FIG. 9) generally opposite the front surface. For example, the panel 111 can suitably be a generally rectangular panel having a substantially uniform thickness and in which the top 113 is generally parallel to the bottom 115 and the sides 117 are generally parallel to one another, as illustrated in FIG. 5. The panel 111 can be made of stone (e.g., a decorative marble, granite, or the like), glass, stainless steel, a mirror, or other suitable materials. If desired the panel 111 can be transparent or translucent to allow lighting incident on the back surface 119 to pass through the panel to the front surface 121, as will be described in more detail below. However, the panel 111 or other body can be opaque to transmission of light within the scope of the invention.

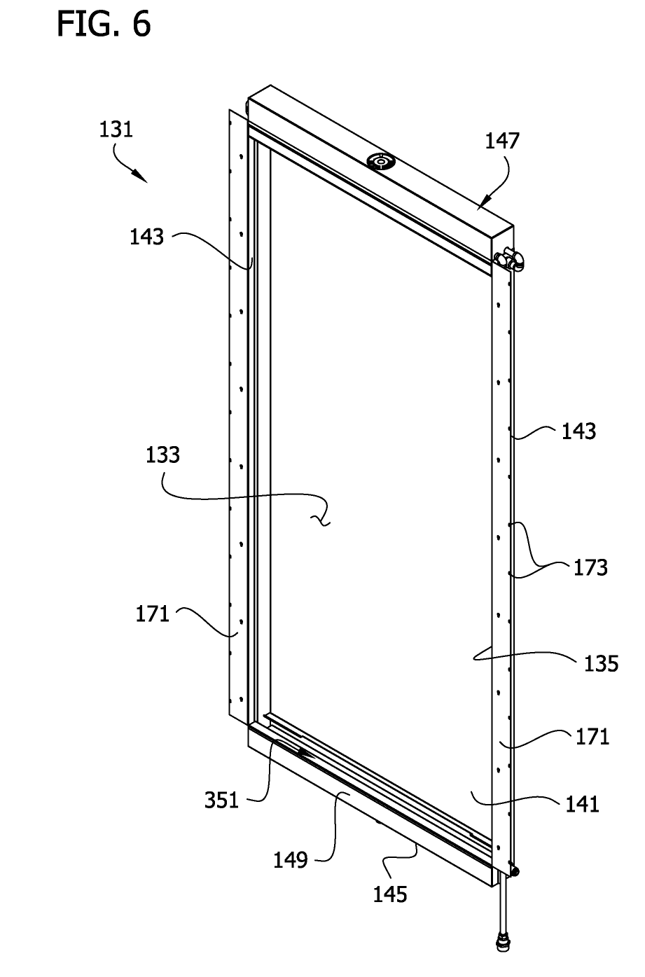

The display unit 105 includes a housing 131 (FIG. 6) that is adapted to hold the panel 111 in a generally upright orientation in which the sides 117 and front surface 121 of the panel are generally vertical. The housing 131 in this embodiment defines a space 133 sized and shaped to receive the panel 111. For example, the space 133 in the illustrated embodiment is generally rectangular and generally corresponds to the shape of the panel 111. The front surface 121 of the panel 111 faces an opening 135 in the housing 131 when the panel 111 is received therein so the housing does not block viewing of at least a portion of the front surface of the panel.

Still referring to FIG. 6, the housing 131 has a back wall 141, side walls 143 extending forward from opposite sides of the back wall, a bottom wall 145 extending forward from a bottom of the back wall, and a top assembly (generally indicated at 147) extending forward from a top of the back wall. The housing 131 also has a front wall 149 extending up from the bottom wall 145 and spaced from the back wall 141 of the housing. The front wall 149 is substantially shorter than the back wall 141. The opening 135 for viewing the panel 111 is above the front wall 149. The size and shape of the housing can be varied to adapt the housing to being mounted on various different structures within the scope of the invention.

Referring to FIGS. 1-4, the housing 131 is suitably configured to facilitate installation of the water display unit 105 in a wall 151 of a building, particularly for such a wall comprising a plurality of studs 153 spaced from one another within the wall and one or more sheets of drywall 155 or other wall substrate material secured to the studs. The housing 131 is suitably configured so it can be mounted in the space 159 between two of the studs 153. Depending on the width of the display unit 105 and the spacing between the studs 153, one or more studs may be removed from the wall 151 to make space for the display unit. When secured to the wall 151 in this manner, the housing 131 is positioned to hold the panel 111 between the studs 153 and recessed in the wall 151 relative to the front surface of the drywall 155, as illustrated in FIG. 1. The housing 131 can suitably dimensioned to fit in the space between 2×4 inch studs 153 to facilitate installation of the water display unit 105 in a wall made from 2×4 inch studs having standard spacing. The studs can be larger (e.g., 2×6 inch studs) without departing from the scope of the invention. When the water display unit 105 is installed in a wall having 2×4 inch studs 153 there is a small gap (e.g., about 0.5 inches wide) between the back wall 141 of the housing 131 and the drywall (if there is any) on the back of the wall. This gap will be larger if the same size water display unit 105 is installed in a wall made from 2×6 inch studs.

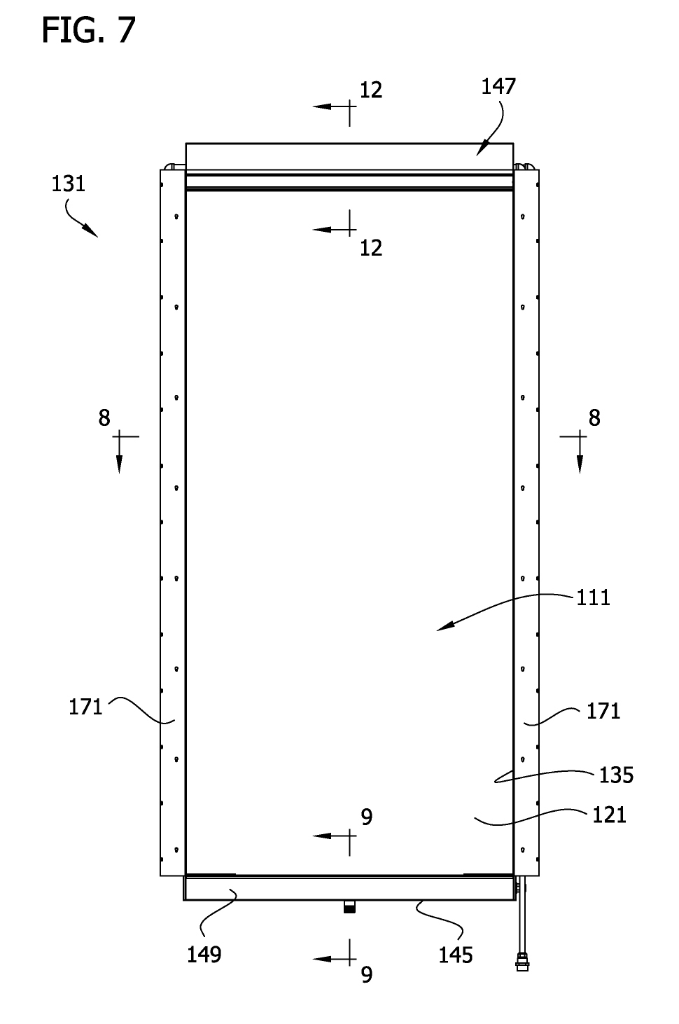

The housing 131 suitably has mounting flanges 171 (FIGS. 3-8) extending outward from the ends of the sidewalls 143 opposite the back wall 141 of the housing to facilitate installation of the housing in the wall 151. The mounting flanges 171 are suitably generally parallel to the back wall 141 of the housing 131. The mounting flanges 171 extend laterally from the sidewalls 143 a sufficient distance to extend at least partially over the front surface of the adjacent stud 153 in the wall 151. Screws or other suitable fasteners (not shown) secure the mounting flanges 171 to the studs 153 and/or drywall 155 (e.g., through holes 173 punched in the mounting flanges) to mount the housing 131 on the wall 151. The housing 131 is suitably sized and shaped so there is a gap 179 between at least one of the sidewalls 143 and the adjacent stud 153 in the wall 151. As illustrated in FIGS. 3 and 4, there are gaps 179 between the studs 153 and the housing sidewalls 143 on each side of the housing 131. Each gap 179 is suitably at least about 2.5 inches wide (e.g., about 3.5 inches wide). The gaps 179 provide space to run water and/or electrical lines between the top and bottom of the housing 131 within the wall 151.

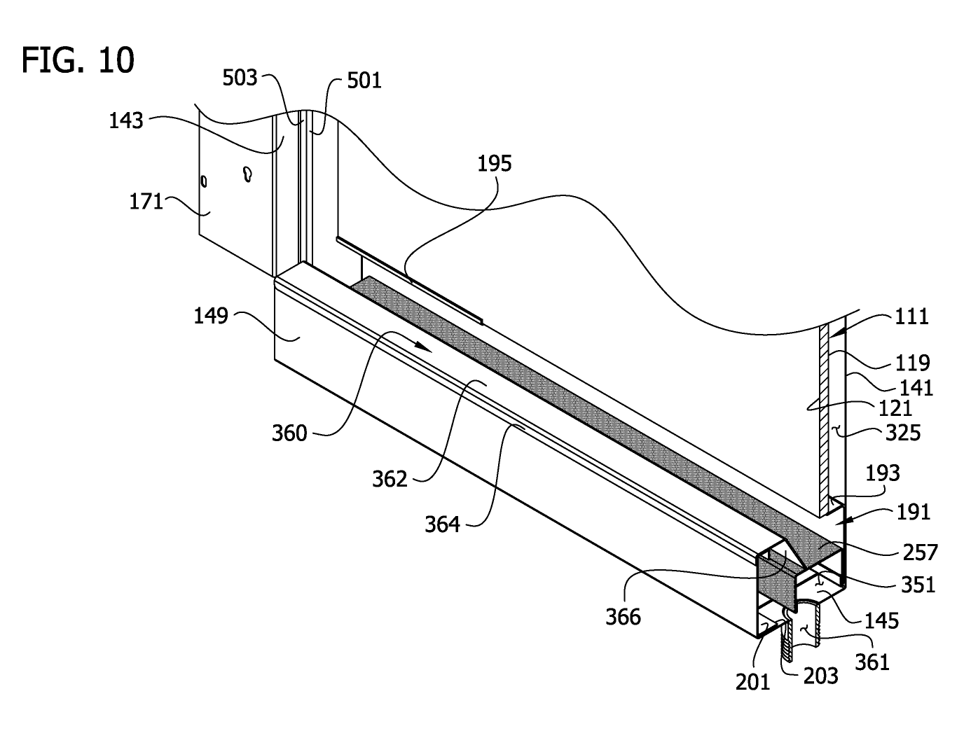

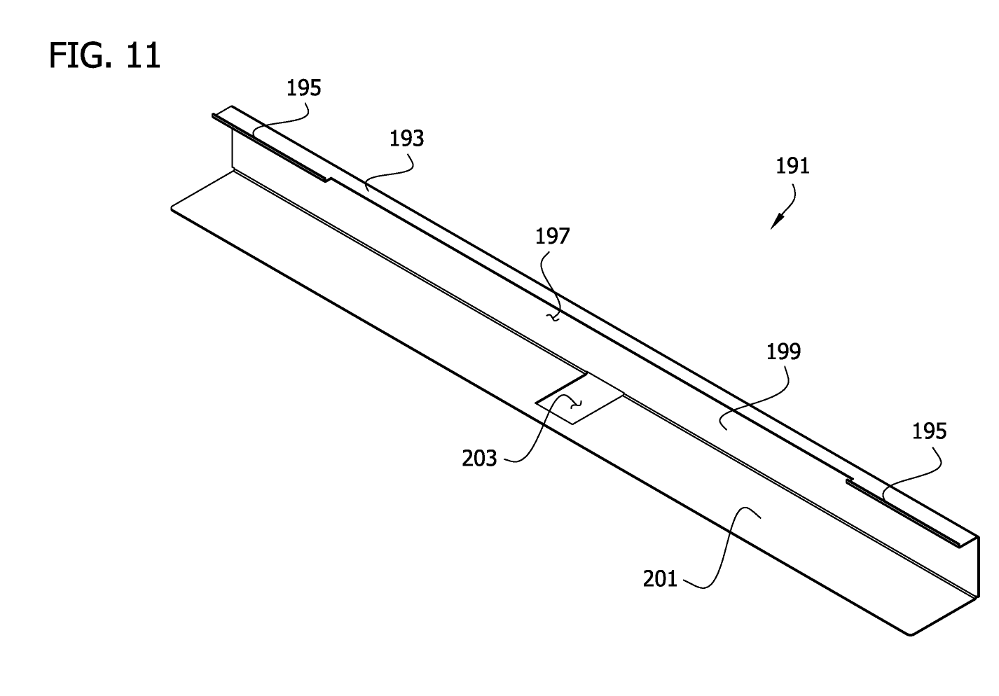

The panel 111 is suitably supported by the housing 131 at an elevation above the bottom wall 145 of the housing, as illustrated in FIGS. 9 and 10. For example, a bracket 191 (FIG. 11) is secured to the housing 131 (e.g., by welding or other suitable means). The bracket 191 includes a base plate 201 and a back plate 199. The bracket 191 is secured to the housing 131 so the base plate 201 is adjacent the bottom wall 145 and the back plate 199 is adjacent the back wall 141 of the housing 131. An opening 203 is in the base plate 201 to facilitate water drainage through the base plate. The back plate 199 supports a generally horizontal shoulder 193 extending from the back wall 141 of the housing 131 and spaced from the bottom wall 145 of the housing. The shoulder 193 supports the bottom 115 of the panel 111 when the panel is received in the housing 131. The bracket 191 has a pair of retainers 195, one of which is adjacent each side 117 of the panel 111. The retainers 195 extend from the shoulder 193 at the bottom of the panel 111 around to the lower end of the front surface 121 of the panel and help hold the panel in place (see FIGS. 9 and 10). Between the retainers 195, the shoulder 193 does not extend all the way to the front surface 121 of the panel 111, which provides an opening 197 that allows the bottom 115 of the panel to be grasped for placing it into and taking it out of the housing 131. A suitable bracket 191 can be made by bending a flat sheet of material (e.g., of stainless steel).

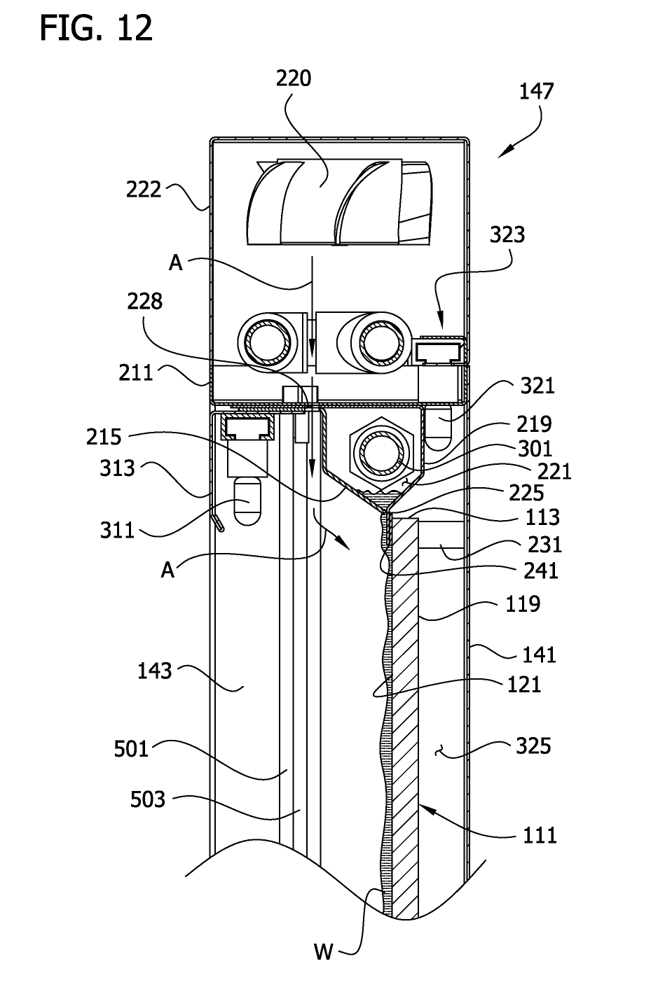

As illustrated in FIGS. 12-14, the top assembly 147 of the housing 131 holds an upper portion of the panel 111 and guides water W pumped to the waterfall display unit 105 to the front surface 121 of the panel, as illustrated in FIG. 12. It is typically desirable for aesthetic reasons to guide the water W to the panel 111 in a manner that produces a sheet of flowing water on the front surface 121 of the panel 111 extending substantially continuously between the sides 117 of the panel (or in some cases between unwetted side margins of the front of the panel).

As illustrated, the top assembly 147 includes a cap 211 sized and shaped to substantially cover the partially defined opening 213 (FIG. 5) at the tops of the back wall 141 and side walls 143 of the housing 131 when the top assembly is secured thereto. A front weir 215 and a rear weir 219 extend down from the cap 211 into the housing 131. The rear weir 219 engages the front surface 121 of the panel at the top 113 of the panel and thereby holds the top of the panel 111 in the housing 131. One or more spacers 231 are positioned between the panel 111 and the back wall 141 of the housing so the panel is held between the rear weir 219 and the spacers.

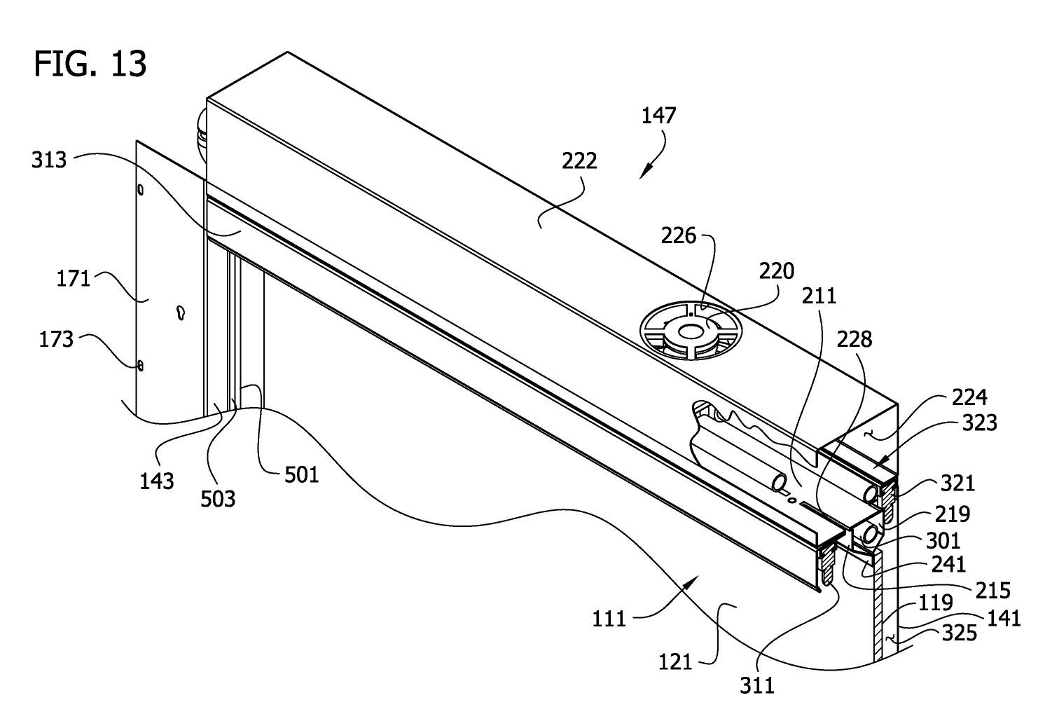

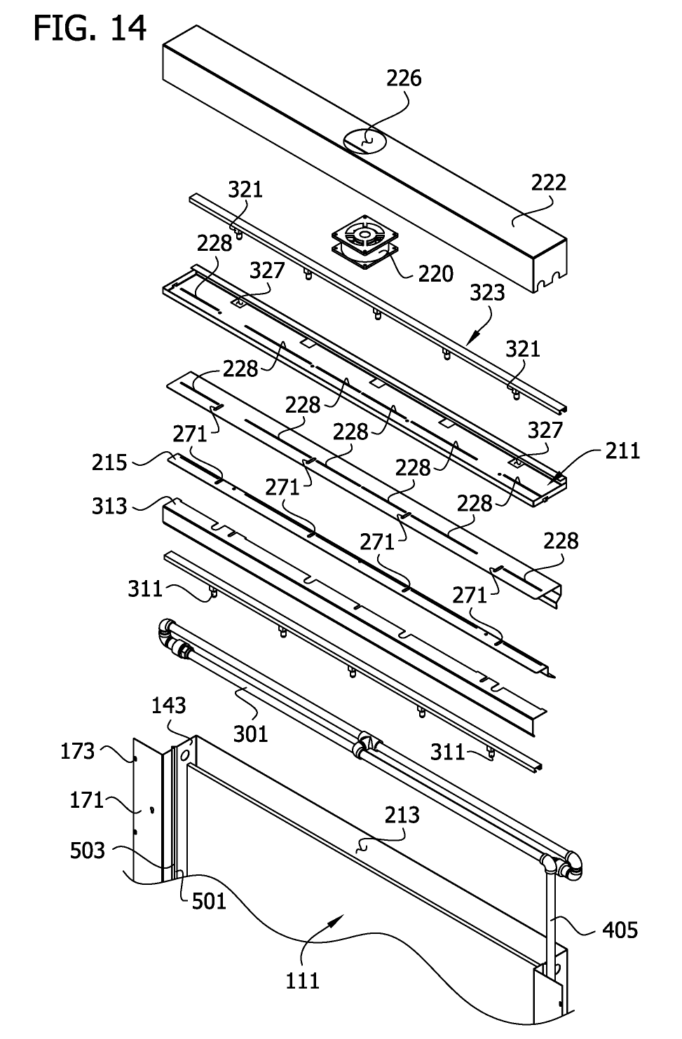

The front and rear weirs 215, 219 in combination with the housing sidewalls 143 define a receptacle 221 for receiving water pumped to the waterfall display unit 105. As illustrated in FIGS. 13 and 14, the front and rear weirs 215, 219 extend substantially continuously between the sidewalls 143 of the housing 131, thereby forming a receptacle 221 that also extends substantially continuously between the sidewalls of the housing. The receptacle 221 also extends substantially continuously between the sides 117 of the panel 111.

As illustrated in FIGS. 12 and 13, the front weir 215 is spaced from the rear weir 219 a small distance (e.g., about a millimeter) at the bottom of the receptacle 221 to form a long thin outlet 225 extending generally parallel to the front surface 221 of the panel 111. A segment 241 of the rear weir 219 extends down from the outlet 225 along the front surface 121 of the panel 111 a short distance at the top of the panel to retain the top of the panel in position and to provide a surface to which water can adhere as it flows from the outlet 225 to the front surface of the panel. The shape of the front and rear weirs can vary within the scope of the invention. The front weir 215 and rear weir 219 illustrated in the drawings can suitably be made by bending sheet metal blanks.

The position of at least one of the front weir 215 and rear weir 219 is suitably adjustable to allow the width of the outlet 225 to be adjusted to match the flow rate from the outlet to the flow rate into the receptacle 221 and to establish a flow rate from the outlet that is suitable for maintaining flow of a continuous sheet of water on the front surface of the panel 111. For example, the front weir 215 and/or rear weir 219 can be secured to the cap 211 by releasable fasteners (e.g., bolts, screws or the like) received in slots 271 in at least one of the cap and the respective weir so the position of the weir can be adjusted (e.g., generally horizontally) relative to the cap to adjust the width of the outlet 225. The ability to adjust the position of the front and rear weirs 215, 219 can also facilitate proper positioning of the weirs relative to the front surface 121 of the panel 111 to adjust for variations in the thickness of panels that may be selected for use in a particular water display unit.

The system 101 suitably includes a manifold 301 (FIGS. 12-14) that receives water pumped from the reservoir 103 and distributes water to the receptacle 221 substantially evenly along its length. For example, a suitable manifold 301 is formed by a substantially horizontal conduit (e.g., pipe) extending between the sides 143 of the housing 131 and having a plurality of outlets (e.g., holes) spaced at intervals (e.g., spaced at substantially equal intervals) along a segment of the conduit that is positioned between the front weir 215 and rear weir 219 and between the housing sidewalls 143 so water pumped from the outlets of the manifold enters the receptacle 221. When the water display unit 105 is operating, the manifold 301 is typically positioned above the water level in the receptacle, although the manifold can be partially or fully submerged within the scope of the invention.

As illustrated in FIGS. 12-14, the top assembly 147 suitably includes lights 311 (e.g., LEDs) positioned to illuminate the front surface 121 of the panel 111 and a light valance 313 that shields direct viewing of the lights by observers in the room containing the display unit 105. The lights 311 suitably extend down short distance into the space 133 in the housing 131 on the side of the front weir 215 opposite the rear weir 219. The light valance 313 suitably extends down from the top assembly 147 on the opposite side of the lights 311 as the front weir 215 to block a direct line of sight to the lights at ordinary viewing angles. The light valence may also block a direct line of sight to the front and rear weirs 215, 219 at ordinary viewing angles, depending on the configuration of the light valence.

One or more lights 321 (e.g., LEDs) can also be positioned in the space below the cap 211 between the rear weir 219 and the back wall 141 of the housing 131, as illustrated in FIGS. 12 and 13. From this position, the lights 321 can shine into the gap 325 between the back wall 141 of the housing 131 and the panel 111. If the panel 111 is transparent or translucent to the light, at least some light incident on the back 119 of the panel can pass through the panel and be perceived by viewing the front surface 121 thereof.

In the illustrated embodiment, the display unit 105 has a backlighting unit 323 that extends through one or more openings 327 (FIGS. 13 and 14) in the top of the housing to facilitate connection of the lights 321 in the backlighting unit to a power supply and/or control system exterior of the housing 131 via one or more electrical lines (not shown) connected to the backlighting unit 323 above the top of the housing. As illustrated in FIGS. 12 and 13, a portion of the backlighting unit 323 (e.g., just the lights 321) extends through the opening(s) 327 in the top assembly 147 (e.g., in the cap 211) in registration with the gap 325 between the panel 111 and the back wall 141 of the housing. The backlighting unit 323 suitably includes a plurality of lights 321 spaced at various positions between the sides 117 of the panel 111 and/or between the sides 143 of the housing along the back surface 119 of the panel. The opening(s) 327 suitably have a size and shape corresponding to the size and shape of the portion of the backlighting unit 323 that is received in the opening. As illustrated in FIGS. 13 and 14, for example, a series of openings 327 extends along the back of the panel 111 and each opening is sized and positioned to receive one of the lights 321.

The lights 311 positioned to light the front of the panel 111 as well as the lights 321 positioned to light the back of the panel can suitably each be part of LED lighting systems. Suitable LED lighting system can be obtained from Phillips Color Kinetics, such as the ColorCast LED light system. Operation of the lights 311, 321 can be controlled by the control system 701, which may be adapted to vary the lighting effects automatically and/or in response to user input. It will be understood the water display unit 105 may include only the lights 311 in front of the panel 111, or only the lights 321 illuminating the back of the panel, or as illustrated, both sets of lights. It is also understood that other lighting may be provided in addition to or instead of the lighting described herein within the scope of the invention.

Further, as illustrated in FIGS. 12-14, one or more fans 220 are suitably positioned in the water display unit 105 to augment flow of air over the front surface 121 of the panel 111. The ability to increase air flow over the sheet of water provides several benefits. First, the air drawn into the fan 220 comes from the room in which the water display unit 105 is installed and carries with it dust and other airborne contaminants Airborne contaminants tend to have positive electrostatic charge while the flow of water W over the panel 111 tends to generate a negative electrostatic charge. Thus, airborne particles are attracted to the flowing water W, which captures the particles and removes them from the air. Increased airflow over the water W also allows for increased evaporation and/or condensation rates during humidification or dehumidification, which will be described below.

As illustrated in FIGS. 12-14, the fan 220 is positioned in the top assembly 147 above the cap 201. In particular the fan is mounted on the upper surface of a plenum 222, which is sized and shaped so the plenum and cap 201 together generally enclose a space 224 above the cap 201 in the top assembly 147. The fan 220 is suitably in the space 224 enclosed by the plenum 222 and an opening 226 in the plenum is aligned with the fan inlet so the fan can draw air into the space through the opening. The fan 220 draws air from the wall space above the top assembly into the plenum 222. The wall space is not sealed from the indoor air in the room and air from the room in which the water display unit 105 is installed flows into the wall space through one or more gaps associated with the installation of the water display unit in the wall 151.

One or more openings 228 are provided in the top assembly 147 to allow air to flow from the space 224 enclosed by the plenum 222. The openings 228 are suitably positioned to direct airflow A (FIG. 12) down from the top assembly 147 toward the front surface 121 of the panel. As illustrated in FIGS. 13 and 14, for instance a series of slot openings 228 extends generally between the side walls 143 of the housing 131. Each of the slots 228 extends substantially parallel to the upper edge 113 of the panel 111. The slot openings 228 are offset relative to the front surface 121 of the panel in a forward direction. For example, as illustrated in FIGS. 12 and 13, the slot openings 228 are positioned in front of the receptacle 221 formed by the front and rear weirs 215, 219. The slot openings 228 extend through the cap 201 and front weir 215 so air from the interior 224 of the plenum can flow through the openings as illustrated by the arrow A in FIG. 12. Once the air has exited the openings 228, it can interact with the water W flowing down the front surface 121 of the panel 111.

In addition to holding the panel 111, the housing 131 also temporarily contains water displayed by the waterfall display unit 105 after it has reached the bottom 115 of the panel 111. For example, the housing 131 is suitably constructed so the seams between the sidewalls 143 and the front 149 and bottom walls 145 of the housing are substantially watertight (e.g., by continuously welding the seams). A catch basin 351 (FIGS. 9 and 10) for collecting water in the housing 131 at the bottom of the panel 111 is suitably formed by the front wall 149, bottom wall 145, back wall 141, and sidewalls 143 of the housing. The front wall 149 suitably has a lip 355 extending inward and downward from the top of the front wall to limit escape of water associated with any splashing that may occur in the catch basin 351. Further, a splash guard 257 is suitably positioned at the bottom of the panel 111 in the catch basin 351 to limit splashing in the basin 351. The splash guard 257 is suitably made from perforated stainless steel. As illustrated in FIGS. 9 and 10 the splash guard 257 has vertical sides 257a and a horizontal top 257b extending between the sides. The splash guard 257 can be made by bending a sheet of perforated stainless steel.

The housing 131 has at least one opening 361 (e.g., a central opening in the bottom wall) that allows water to drain from the catch basin 351. In the illustrated embodiment, the housing 131 has a second opening 365 (FIG. 5) spaced above the bottom wall 145 to provide a secondary drain to prevent overflow in the event the primary drain 361 does not drain water fast enough, such as might happen if the primary drain is obstructed. The drain 361 and overflow drain 365 are suitably connected by conduits 405 of the fluidic system 401 (FIGS. 3 and 4) to the reservoir 103 so water drained from the housing 131 is returned to the reservoir (e.g., by gravity flow).

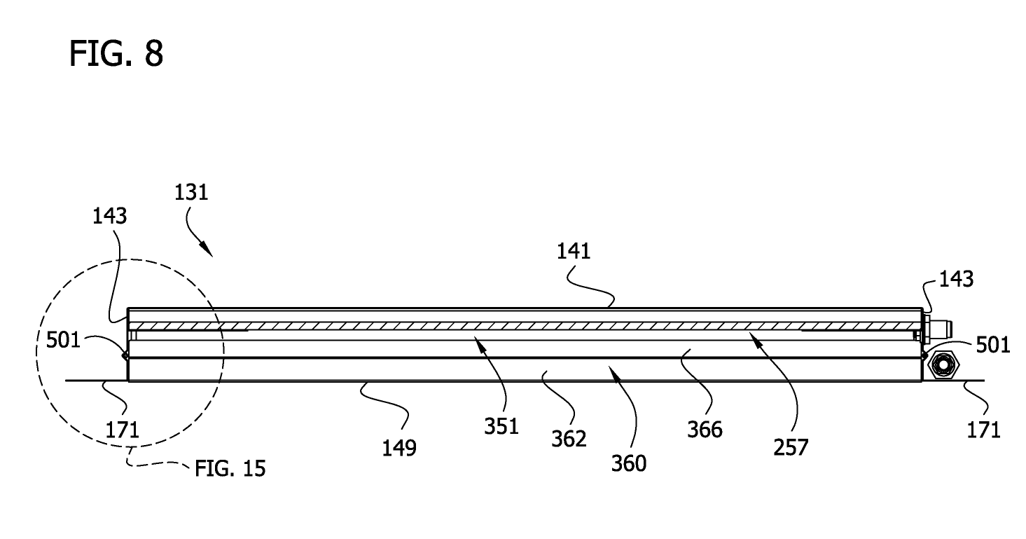

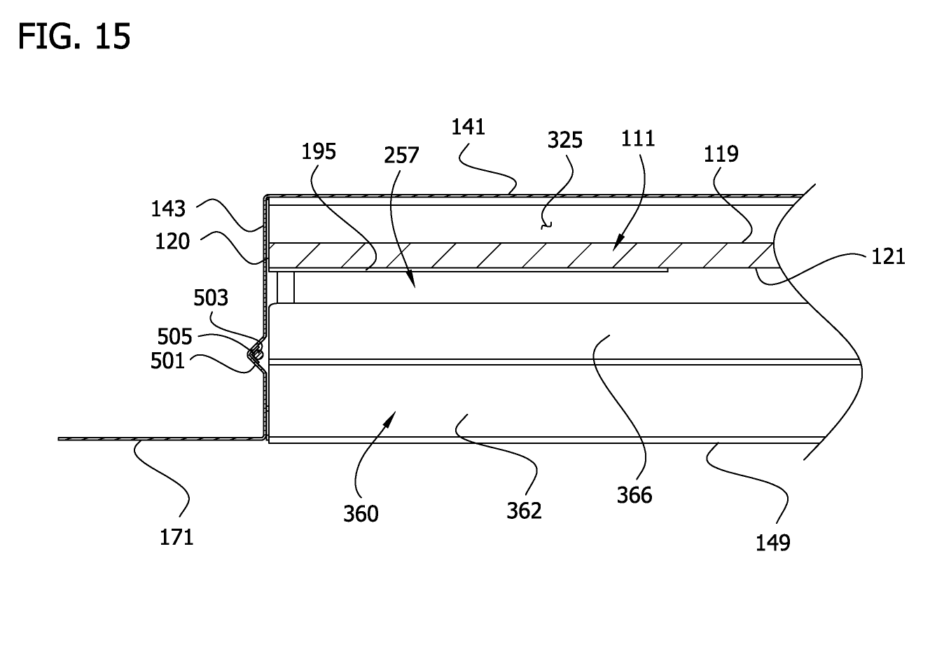

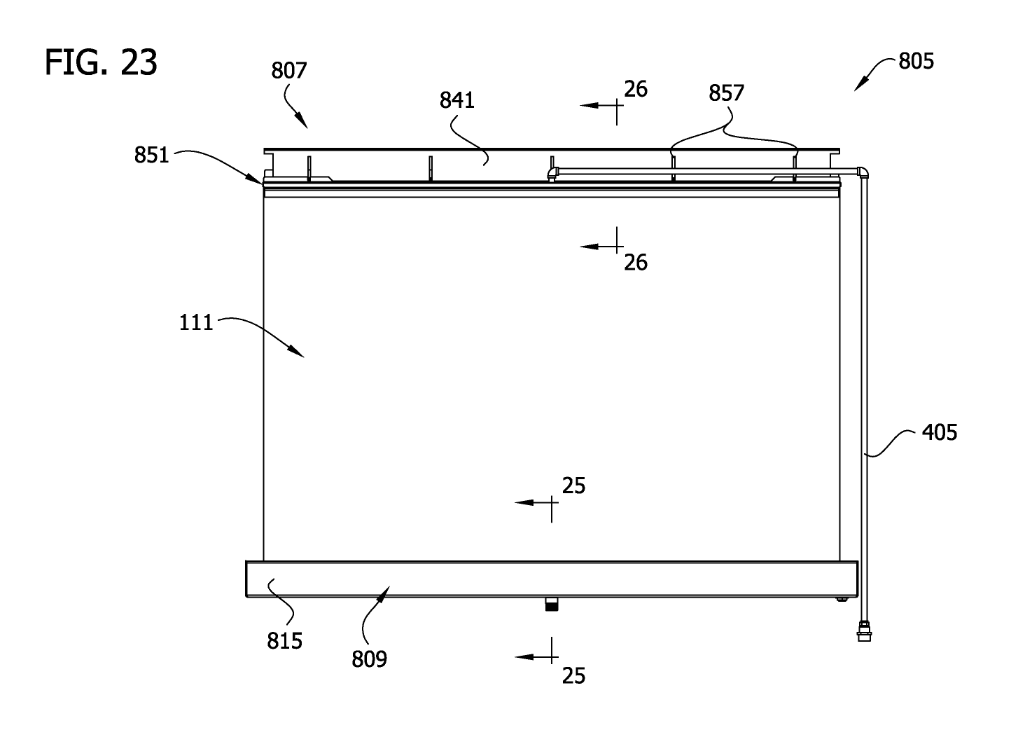

It has sometimes been observed that small amounts of water can be transported away from the panel 111 along the sidewalls 143. If left unchecked, moisture from the water flowing through the water display unit 105 could adhere to the surface of the sidewalls 143 and be transported to the front of the sidewalls and then along the mounting flanges 171 to the studs 153 and/or drywall 155 or other wall substrate material. Accordingly, the housing is suitably constructed to limit this transport of moisture out of the housing 131 along the sidewalls 143. As illustrated in FIG. 15, a channel 501 is formed in one of the sidewalls 143 and extends along at least one side 117 of the panel 111. In the illustrated embodiment, each of the sidewalls 143 has its own channel 501 (see FIG. 8), but it is possible to construct a housing having a single channel that extends circumferentially around the housing so the same channel extends along both sides of the panel 111 within the scope of the invention. The channel 501 is spaced from the front surface 121 of the panel 111. The channel 501 has a cross sectional shape that tapers from a relatively wider width at an open side of the channel to a relatively narrower width at a closed side of the channel opposite the open side. For example, as illustrated in FIG. 23, the channel 501 is suitably V-shaped in cross section. It is understood the channel can have other cross sectional shapes within the scope of the invention.

A barrier 503 is positioned in the channel 501 to limit movement of water along the sidewall 143 away from the panel 111. The barrier 503 is suitably secured in the channel 501 so it extends along at least a segment of the channel. The barrier 503 is suitably a substantially cylindrical rod having a substantially circular cross section. The barrier 503 is suitably secured in the channel 501 with an adhesive 505 (e.g., double sided VHB adhesive tape, which is commercially available from 3M Co. of MN). The barrier 503 is suitably constructed of acrylic, stainless steel, or the like. In the illustrated embodiment, a substantially similar barrier 503 is secured in each of the channels 501 and in substantially the same way.

A condensation guard 360 (FIGS. 9 and 10) is also positioned in the catch basin to limit formation of condensation on the sidewalls 143 in front of the water barrier 503 near the catch basin 351. The condensation guard 360 is suitably a vapor barrier extending from the lip 355 on the front of the housing 131 to the barrier 503 in the sidewall 143. Without the vapor barrier provided by the condensation guard, there can be a tendency for water vapor from the catch basin 351 to condense on the sidewalls 143 of the housing near the bottom of the sidewall 143 in front of the barrier 503. If sufficient water is condensed on the sidewalls 143 at these locations, the water can flow from the sidewalls along the mounting flanges 171 to the studs 153 and/or drywall 155. As illustrated, the condensation guard 360 has a generally horizontal plate 362 extending from the front wall 149 of the housing 131 above the catch basis 351 toward the panel 111 to at least the barriers 503 embedded in the sidewalls 143. The plate is retained in position by a retaining lip 364 hooked over the upper lip 355 of the front wall 149 and a support leg 366 angling down from the barrier 503 to the upper portion 257b of the splash guard 257, upon which it sits. The condensation guard 360 can be made of any material that is substantially impermeable to water vapor. For example, a sheet of un-perforated stainless steel can be bent into the shape of the condensation guard.

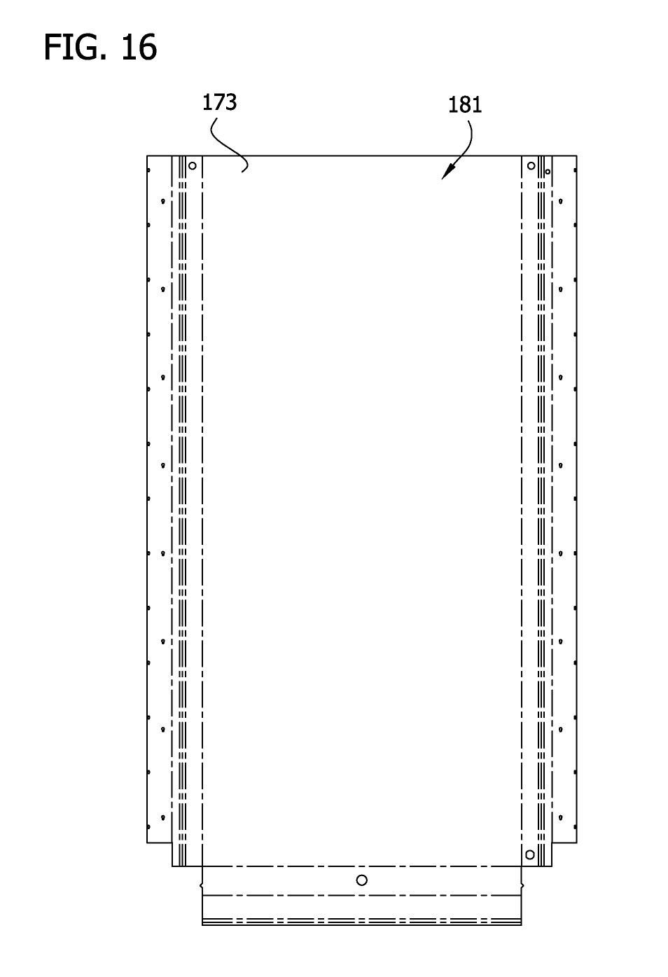

The housing 131 can suitably be constructed from a blank 181 made by cutting a flat sheet of suitable material (e.g., stainless steel) to have the shape illustrated in FIG. 16 and bending the blank along the dashed lines to form the back wall 141, side walls 143, front wall 149, and mounting flanges 171. The channels 501 in the side walls are suitably also made by bending the blank 181 to form the channels 501 in the sidewalls 143. The top assembly 147 is then secured to the tops of the back wall 141 and side walls 143 using any suitable fastening system (not shown).

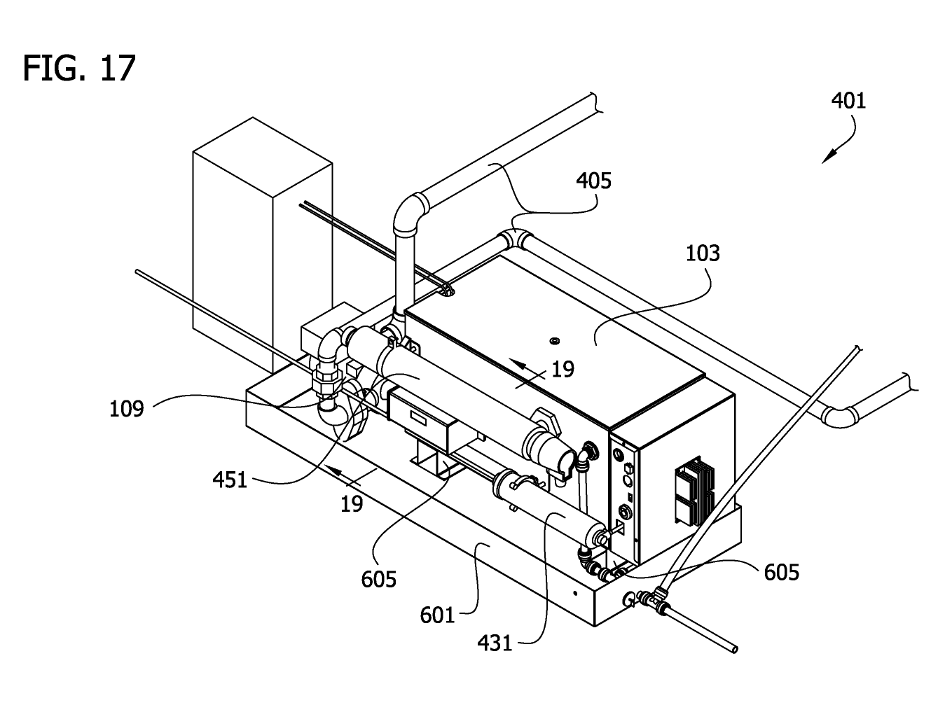

Referring primarily to FIGS. 17-20, the fluidic system 401 includes the pump 109 for pumping water from the reservoir 103 to the water display unit 105. The fluidic system 401 also includes a fluidic circuit that has suitable conduits 405 for conveying water from the reservoir 103 to the display unit 105 and returning water from the display unit to the reservoir. In the illustrated embodiment, the water drains from the display unit 105 and returns to the reservoir 103 under the influence of gravity. However, if needed, a second pump could be used to pump water from the display unit back to the reservoir.

The control system 701 is operable to fill the reservoir 103 and drain the system using various electronically actuated valves (FIG. 20) in the fluidic system 401. For example, the system 101 suitably includes a solenoid actuated fill valve 415 that is responsive to signals from the control system 701 to control flow of water into the reservoir 103 from an external water supply, such as the plumbing system of the building that contains the display unit 105. It is desirable to filter water provided to the system 101 to limit formation of mineral deposits in the system. A suitable filter 431 uses a combination of phosphate and sediment to filter water as it flows into the system 101. The phosphate in the filter 431 helps limit formation of mineral deposits by encapsulating minerals such as magnesium and calcium that may be present in the water. The filter 431 suitably substantially avoids removing chlorine from the water.

A fill sensor 421 in the reservoir 103 provides a signal to the control system 701 when the water level in the reservoir is below a threshold level. The control system 701 is suitably adapted (e.g., by programming) to open the fill valve 415 when the fill sensor 421 indicates the water level in the reservoir 103 is below the threshold level and then close the fill valve after the reservoir has been replenished with water. The system 101 also includes a drain valve 417 responsive to signals from the control system 701 to control flow of water out of the reservoir 103 into a drain. The drain valve 417, like the other valves controlled by the control system 701, can be a solenoid actuated valve.

The reservoir 103 and other parts of the fluidic system that may be susceptible to leaking or on which condensation may form are positioned in a reservoir pan 601 that catches any water leaking from the reservoir or other components located in or above the reservoir pan. The reservoir pan 601 suitably includes brackets 605 (FIG. 17) that hold the reservoir 103 a short distance above the bottom of the reservoir pan. A leak sensor 425 (FIG. 20) in the reservoir pan 601 determines whether or not a significant amount of water has leaked into the reservoir pan and provides a corresponding signal to the control system 701. Because the reservoir pan 601 does not contain a significant amount of water when the system 101 is operating properly, presence of a significant amount of water in the reservoir pan is indicative of a problem. Accordingly, the control system 701 is suitably adapted to shut off the water display unit 105 by turning the pump 109 off, closing the fill valve 415 to shut off water supply to the reservoir 103, and opening the drain valve 417 to empty the reservoir when the leak sensor 425 detects a significant amount of water in the reservoir pan 601. This provides a safety feature that helps protect against water damage in the event of a leak or other system problem that would result in overflow of water from the system 101.

As illustrated in FIG. 17, the pump 109 is suitably inside the reservoir pan 601, but outside the reservoir 103. Alternatively, the pump can be a submersible pump contained in the reservoir within the scope of the invention. The conduits 405 connect the pump to the manifold 301 in the receptacle 221 at the top of the water display unit 105 so water pumped from the reservoir 103 by the pump 109 is conveyed to the water display unit. The conduits 405 also connect the drain 361 and overflow drain 365 of the housing 131 to the reservoir 103 so water drained from the catch basin is returned to the reservoir through the conduits.

The control system 701 suitably includes a humidity control system operable to adjust the humidity level of the air (broadly, a gas) in the interior space that contains the display unit 105. The humidity control system suitably includes a humidity sensor 705 (FIG. 20) positioned to measure the humidity of the interior space containing the display unit 105 and send signals indicative of the humidity level to the control system 701. One suitable humidity sensor is a humidistat from Honeywell International, Inc. commercially available as part No. CH17178. This humidistat can suitably be mounted on a circuit board inside the control panel 703. One or more openings (e.g., slots) is suitably provided in the control panel housing to facilitate monitoring of humidity exterior of the housing by the humidistat mounted on the circuit board inside the control panel (e.g., adjacent one of the openings).

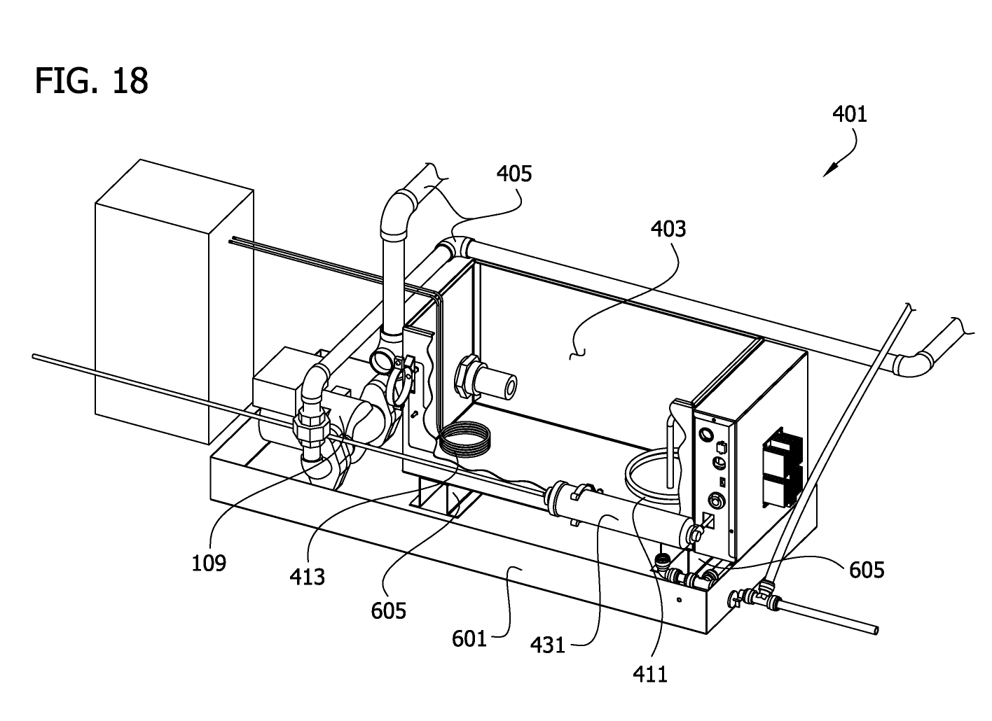

The humidity control system also includes a temperature control system adapted to adjust the temperature of the water in the reservoir. The temperature control system is suitably operable to raise the temperature of the water in the reservoir 103 in order to increase humidity and decrease the temperature of the water in the reservoir to decrease the humidity. As illustrated in FIG. 18, a heater 411 is suitably positioned in the reservoir 103 to heat the water. A chiller rod 413 can suitably be positioned in the reservoir 103 to cool the water. A suitable chiller is commercially available from Aqua Logic, Inc. of San Diego, Calif. under the name Cyclone® Titanium water chiller. Other chillers can be used within the scope of the invention. Alternatively, if the water display unit 105 is installed in a facility (e.g., a hospital or the like) that already has a supply of pre-chilled water, the temperature control system can be adapted to add pre-chilled water to the reservoir 103 (and drain warmer water in the reservoir if necessary) to cool the water temperature and decrease humidity. A temperature sensor 711 in the reservoir 103 provides signals to the control system 701 indicative of the temperature of the water in the reservoir 103.

When the humidity sensor indicates the humidity is lower than a desired minimum humidity, the control system 701 causes the temperature control system to raise the temperature of the water in the reservoir (e.g., by activating the heater 411). This results in an increase in the temperature of the water flowing over the panel 111 or other body in the display unit 105. As the water flows over the body 111, it contacts the air in the room that contains the display unit 105. When the temperature of the water is relatively high because of the heating by the heater 411, more water evaporates from the display unit 105 into the air. This evaporation of water increases the humidity in the room.

When the humidity sensor 705 indicates the humidity is above a maximum desired humidity, the control system reduces the temperature of the water in the reservoir 103 (e.g., by activating the chiller rod 413 or adding pre-chilled water to the reservoir). This results in a decrease in the temperature of the water flowing over the panel 111 or other body in the display unit 105. Consequently, the temperature of the panel 111 is lowered by the relatively cooler water causing water vapor to condense on the back surface 119 of the panel 111 and drain into the bottom of the housing 131. Gaps 120 (FIG. 15) between the panel 111 and the sidewalls 143 of the housing 131 allow air from the room containing the water display unit 105 to circulate behind the panel. Thus, the water vapor that condenses on the back of the panel 111 is removed from the air in the room. This produces a decrease in the humidity in the room. When the dehumidifying option is used, it is desirable to use a panel 111 made of glass or another material having a relatively high thermal conductivity so cooling on the front surface 121 of the panel is conducted readily through the panel to the back surface 119. Further, formation of condensation may be an issue when dehumidifying because the relatively cooler water may cool the temperature of the catch basin 351 and cause water to condense on the exterior of the housing 131. Thus, it is sometimes desirable to use an insulated catch basin (not shown) when the dehumidifying option is used (e.g., a double stainless steel pan with an air gap between the pans or an insulated plastic material that does not sweat) to limit and desirably prevent negative impacts on the wall 151 associated with release of moisture from the display unit 105.

High indoor humidity can cause problems, particularly when there is cold weather and the inner surfaces of exterior walls are cool enough to cause condensation to form on the walls. If condensation forms on the walls, this can create a favorable environment for mold growth and can lead to other problems. The humidity control system suitably includes safeguards that reduce the risk of over humidification. For example, the humidity control system suitably includes a temperature sensor 707 that monitors the temperature outside the building containing the display unit and sends signals to the control system 701 (e.g., wirelessly) indicative of the temperature outside the building that contains the display unit 105. The control system 701 is suitably adapted (e.g., by suitable programming) to maintain a reduced interior humidity level when the temperature sensor 707 indicates the exterior temperature outside is below a threshold temperature. The control system 701 is also adapted (e.g., by programming) to allow a user to intervene and manually adjust the humidity levels that are to be maintained by the humidity control system.

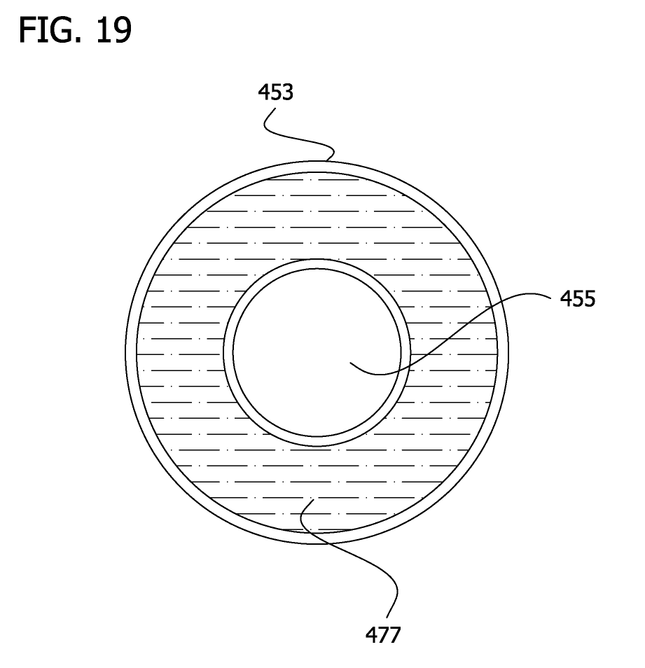

The water display system 101 suitably includes a cleaning system operable to automatically clean the fluidic system 401. The cleaning system suitably includes a sanitizing system 451 operable to limit microbial growth in the system 101. The sanitizing system 451 suitably includes an ultraviolet light 455 positioned to expose water in the fluid circuit to ultraviolet radiation as the water flows through the fluid circuit. As illustrated in FIG. 19, the ultraviolet light 455 is positioned within a sleeve 453 mounted on the exterior of the reservoir 103. The sleeve 453 suitably forms a portion of one of the conduits 405. For example, in FIG. 19 the sleeve 453 of the UV sanitizing system 451 is connected to the fluidic system 401 so the water returning from the water display unit 105 flows through the sleeve on its way back to the reservoir 103.

Water flowing through the sleeve 453 (e.g., on its way back to the reservoir 103) flows through an irradiation zone 477 configured such that substantially none of the water in the irradiation zone is spaced from the ultraviolet light 455 by more than about 1 inch. For example, the irradiation zone 477 suitably comprises a thin annular space between the UV light 455 and the inner surface of the sleeve 453. Thus, when the water flows through the sleeve 453 it is constrained by the inner surface of the sleeve 453 and the ultraviolet light 455 to form a relatively thin shell flowing along the outer surface of the ultraviolet light. Thus, substantially all of the water flowing through the sleeve is exposed to ultraviolet radiation produced by the light 455. Moreover, the ultraviolet radiation does not have to penetrate very far into the water to irradiate the water in the irradiation zone 477 that is farthest from the ultraviolet light 455. The distance between the inner surface of the sleeve 453 and the UV light in the irradiation zone is suitably no more than about 1 inch. The flow rate of water through the sleeve 453 and the flux of ultraviolet radiation emitted by the light are suitably selected to enable the sanitizing system to achieve at least 99 percent sanitization (meaning at least 99 percent of microbes in the water that are living when they enter the irradiation zone are killed by exposure to the ultraviolet radiation).

The cleaning system suitably also includes a feature of the control system 701 that automatically drains water from the reservoir 103 and replenishes it with fresh water. For example, the cleaning system is suitably operable to drain water from the system 101 and replenish the system with fresh water according to at least one of the following protocols. The cleaning system is also able keep the fluidic system 401 clean without requiring addition of any chemical cleaners to the water in the system.

In a first protocol, the control system 701 turns the pump 109 off and returns substantially all the water in the water display unit 105 and conduits 405 to the reservoir 103. For example, the water in the catch basin 351 and conduits 405 is suitably returned to the reservoir 103 by gravity after the pump 109 is turned off. Then the control system 701 activates the heater 411 to heat the water in the reservoir 103 to at least about 140 degrees F. Raising the temperature of the water in the reservoir 103 this way increases the volume of the water in the reservoir and kills microbes above a normal water level in the reservoir. Then the control system 701 drains substantially all of the water from the reservoir 103 (e.g., by opening the solenoid actuated drain valve discussed above). When the reservoir 103 is empty, the cleaning system automatically refills the reservoir 103 with a new supply of water (e.g., by opening the solenoid actuated fill valve 415). Then the control system 701 turns the pump 109 back on to resume operation of the water display unit 105. This process can be automatically repeated periodically (e.g., once every 24 hours).

In a second protocol of the cleaning system, the control system 701 replaces the water in the system without turning off the pump 109 and without interrupting operation of the water display unit 105. One advantage of the second protocol is that the water display unit 105 does not need to be turned off, which eliminates the possibility that dry spots may form on the panel 111 and disrupt flow of water over the panel when the water display unit is turned back on. In the second protocol, the control system 701 suitably drains water from the reservoir 103 (e.g., by opening the solenoid actuated drain valve 417) and simultaneously adds fresh water to the reservoir (e.g., by opening the solenoid actuated fill valve 415) for a period of time. The control system 701 is suitably programmed so it automatically repeats this process (e.g., at intervals) until the system achieves a one hundred percent water exchange, suitably in a period ranging from about 1 hour to about 1 week. The control system 701 is suitably also programmed to accept user input allowing a user to selectively increase or decrease the frequency at which the process is repeated (e.g., to select a desired time frame for achieving one hundred percent water exchange). The frequency may be increased if, for example, there is lots of dust or other airborne contaminants in the room in which the water display unit is installed. Alternatively, the frequency may be decreased when environmental conditions are less demanding and frequent water exchange is not needed.

The control system 701 is suitably adapted (e.g., by suitable programming) to enable a user to enter an input to select a first mode in which the control system uses the first protocol to replace water in the system 101 with fresh water or a second mode in which the control system uses the second protocol to replace water in the system with fresh water. The control system 701 is also suitably adapted to enable a user to enter an input to the control system to select a frequency for the repeating step of the second protocol, e.g., using the control panel 703.

Although FIG. 20 indicates there is an RF connection between the control system 701 and the exterior temperature sensor 707 and hard wired connections to the other components of the system 101, it is understood that any of the controller connections can be wireless within the scope of the invention. It is also understood that any of the controller connections (including the connection to the exterior temperature sensor 707) can be through one or more wires within the scope of the invention.

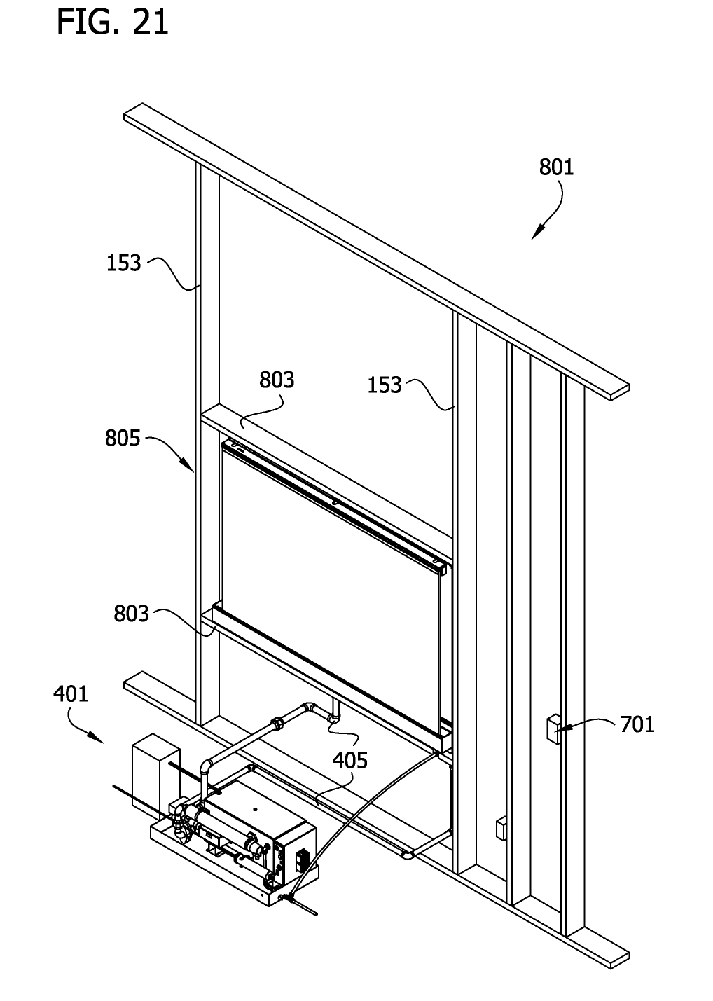

Another embodiment of a water display system, generally designated 801, is illustrated in FIGS. 21-26. This system 801 is substantially similar to the system 101 described above except as noted. One difference is that the system does not use the housing 131 described above. Instead, the housing of the water display unit 805 includes a top assembly 807 supporting the top 113 of panel 111 and a separate bottom assembly 809 supporting the bottom 115 of the panel. As illustrated in FIG. 21, the top and bottom assemblies 807, 809 are supported between the studs 153 by horizontal supports 803 secured to the studs.

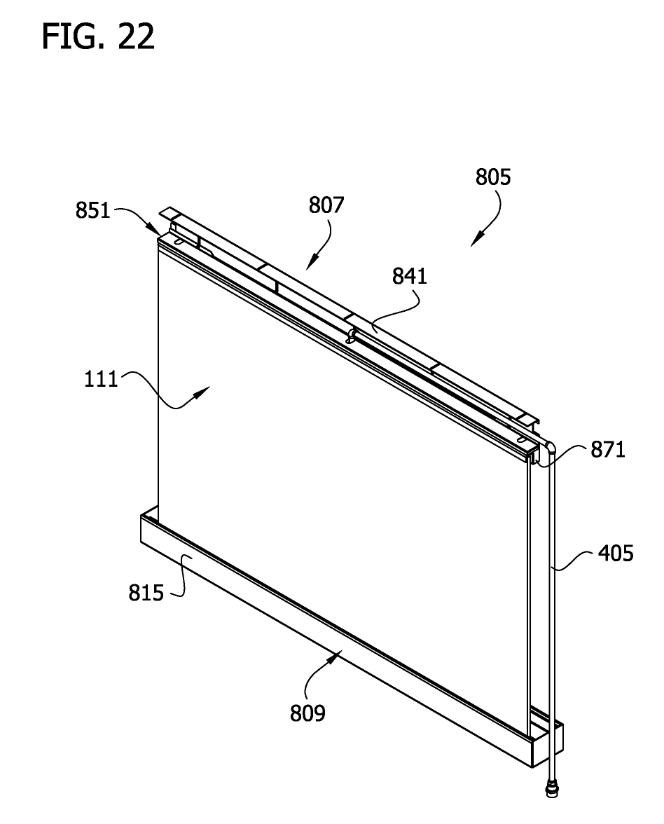

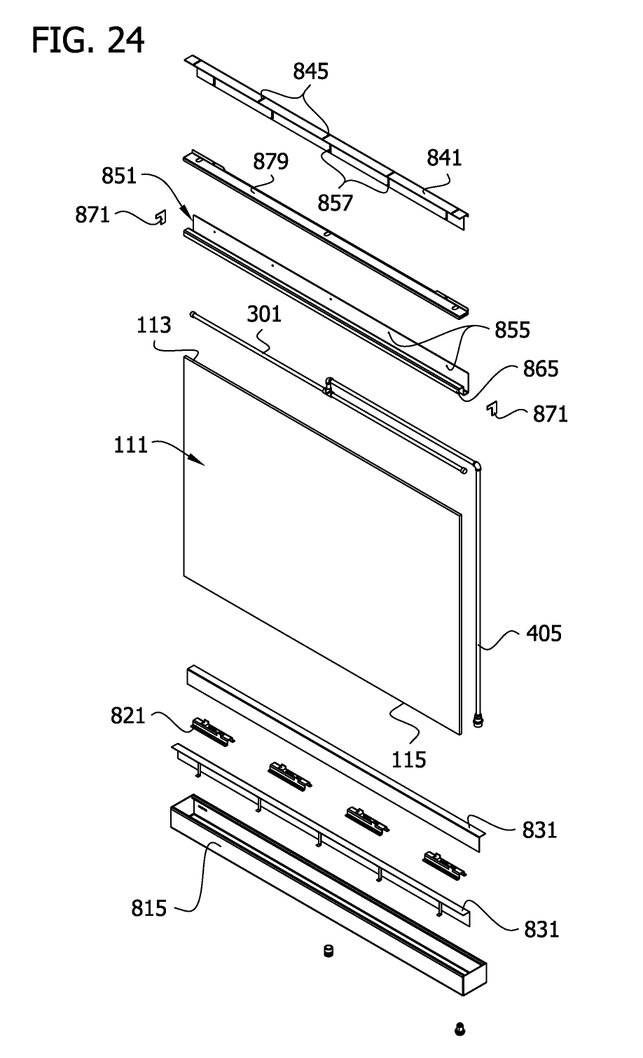

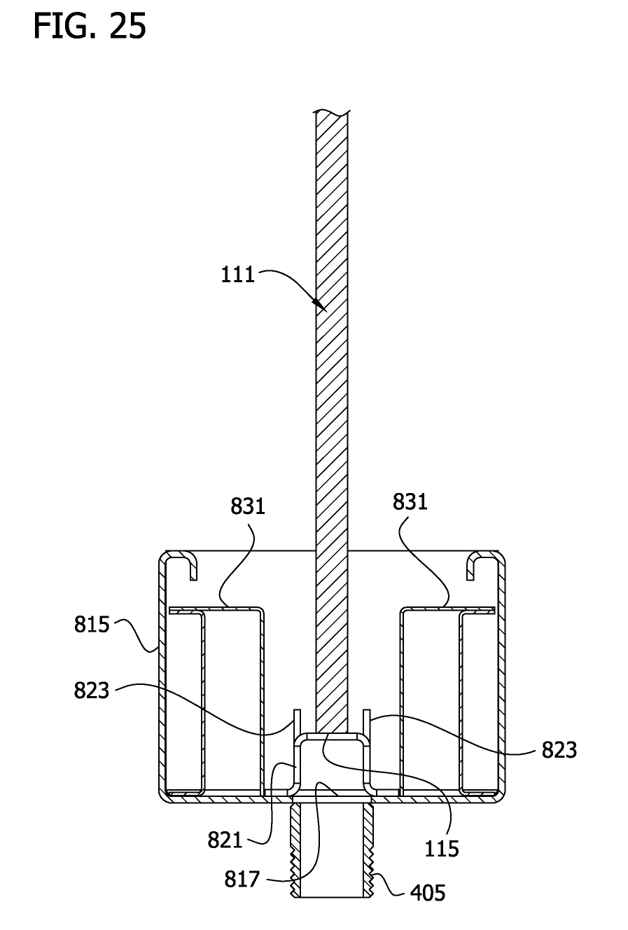

As illustrated in FIGS. 22-25, the bottom assembly 809 includes a catch basin 815 that receives water after it reaches the bottom of the panel and drains water to the fluidic system 401 in substantially the same manner as described for the system 101 above. The catch basin 815 is secured to the upper surface of one of the supports 803, such as by being held in place by a conduit 405 connecting to the drain 817 (FIG. 25) through an opening (not shown) in the support. Brackets 821 (FIGS. 24 and 25) are secured to the bottom of the catch basin 815. The spaced apart brackets 821 have retainers 823 that form a channel for receiving the bottom 115 of the panel 111 and holding the bottom of the panel in the catch basin 815. Splash guards 831 (which are suitably made of perforated stainless steel) are positioned in the catch basin 815 and extend along the bottom 115 of the panel 111.

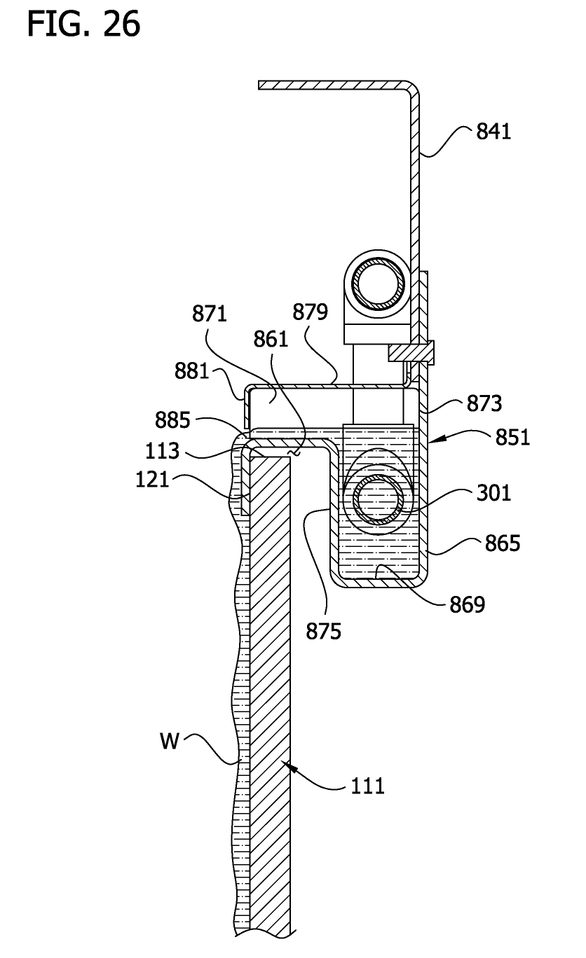

Referring to FIGS. 22-24 and 26, the top assembly 807 includes a top bracket 841 secured to the upper support 803 (e.g., using screws or other suitable fasteners) received in slots 845 (FIG. 24) that facilitate horizontal adjustment to the position at which the bracket is supported. The top bracket 841 supports a weir assembly 851, which is suitably connected to the bracket by screws 853 or other fasteners (FIG. 26) received in openings 855 (FIG. 24) and vertical slots 857 in the bracket 841 which facilitate adjustment to the height at which the weir assembly is supported by the bracket. The weir assembly has a channel 861 (FIG. 26) for receiving the top 113 of the panel 111.

The channel 861 is partially defined by a weir 865 positioned to extend over an upper portion of the front surface 121 of the panel 111 when the top 113 of the panel is in the channel, as illustrated in FIG. 26. The weir assembly 851 has a trough 869 (FIG. 26) adjacent the weir 865. The ends of the trough 869 are sealed in a fluid tight manner by end plates 871 (FIG. 24) secured to the weir 865 at opposite ends of the trough (e.g., by welding or other fluid tight means) so the trough can retain water. The manifold 301 is positioned in the trough 869 so water pumped to the display unit 805 fills the trough. The trough 869 is also constructed so water overflowing from the trough flows out of the trough and down along the portion of the weir 869 extending over the front surface 121 of the panel at the top 113 of the panel. As illustrated in FIG. 26, for example, the end plates 871 and a back wall 873 of the weir 865 extend up from the trough 869 substantially above the front wall 875 of the weir to prevent escape of water overflowing from the trough except over the front wall of the weir and onto the panel 111. A cap 879 extends over the trough 869 between the end plates 871 and is supported by the end plates so a front lip 881 of the cap is positioned slightly above the front wall 875 of the weir 865 to form an outlet 885 for the water W overflowing from the trough. When the pump 109 is turned off, water in the trough 869 is siphoned back to the reservoir through the manifold 301 and conduits 405 of the fluidic system 401 because the manifold is submerged in the trough when it is overflowing.

Because the trough 869 is positioned behind the panel 111 use of the weir assembly is limited to locations where there is sufficient space in the wall for the trough 869 to be positioned behind the panel 111. For example, the weir assembly 851 can be used in display units in which the studs 153 are 2×6 inch studs or where the back of the wall is unfinished so the display unit can extend beyond the back surface of the studs on the back side of the wall. In some cases it may be desirable to create an opening in the back of the wall 151 so the back 119 of the panel 111 can be viewed from the opposite side of the wall. Although the water only flows down the front 121 of the panel 111, if the panel is made of a clear or translucent material (e.g., glass), viewing the back side of the panel can also be aesthetically pleasing. It is noted the weir assembly 851 can be adapted for use in the housing 131 of the water display unit 105 described above instead of the front and rear weirs 215, 219 whenever there is sufficient space in the wall.

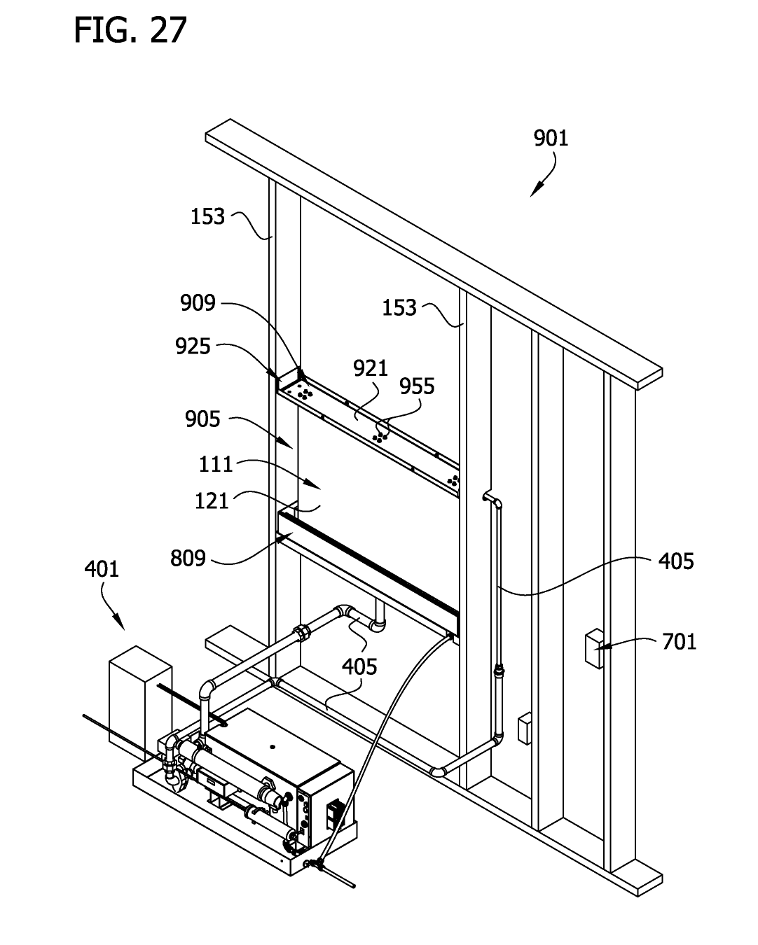

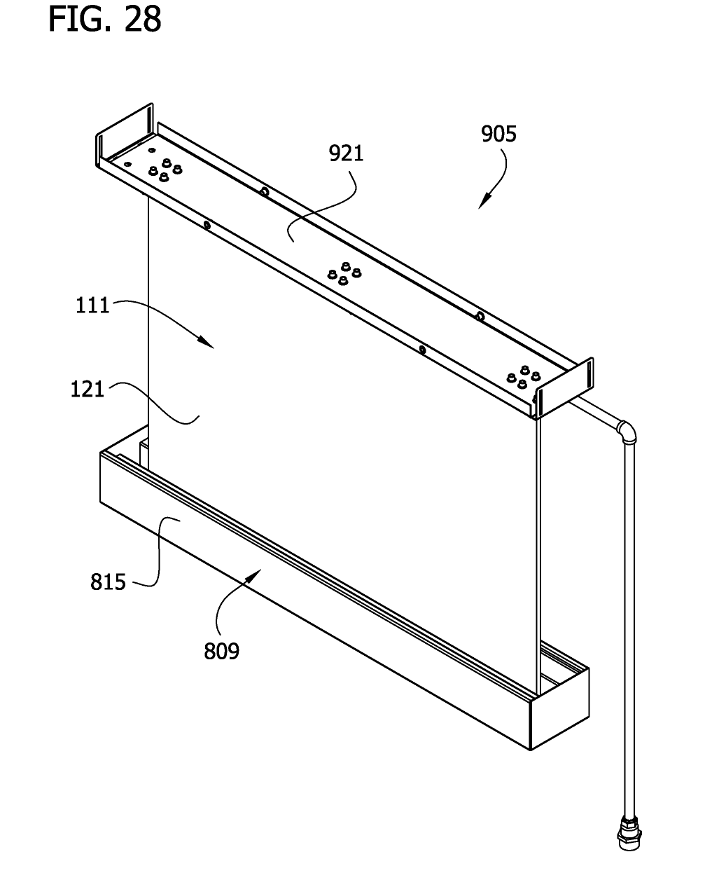

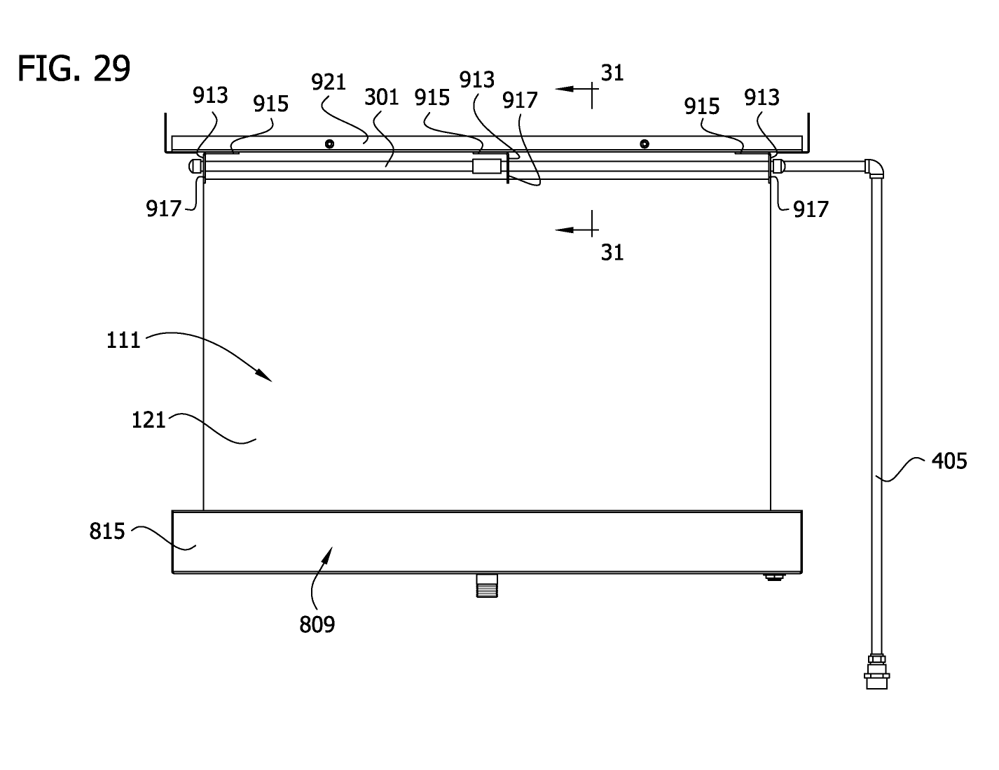

FIGS. 27-31 illustrate another embodiment of an indoor air improvement system, generally designated 901. This system 901 is substantially similar to the system 801 described above, except as noted. The bottom 115 of the panel 111 in this embodiment is supported by the same lower assembly 809 described above. One of the differences between this water display unit 905 and the water display units 105, 805 described above is that this display unit has a top assembly 909 adapted to convey water received from the pump 109 to the top of the panel 111 in a manner that results in water flowing down the front surface 121 of the panel and also down the back surface 119 of the panel. This may be desirable when it is desired to have the decorative aspects of the water display unit 905 viewable from both sides of the wall 151 even when the panel 111 is opaque.

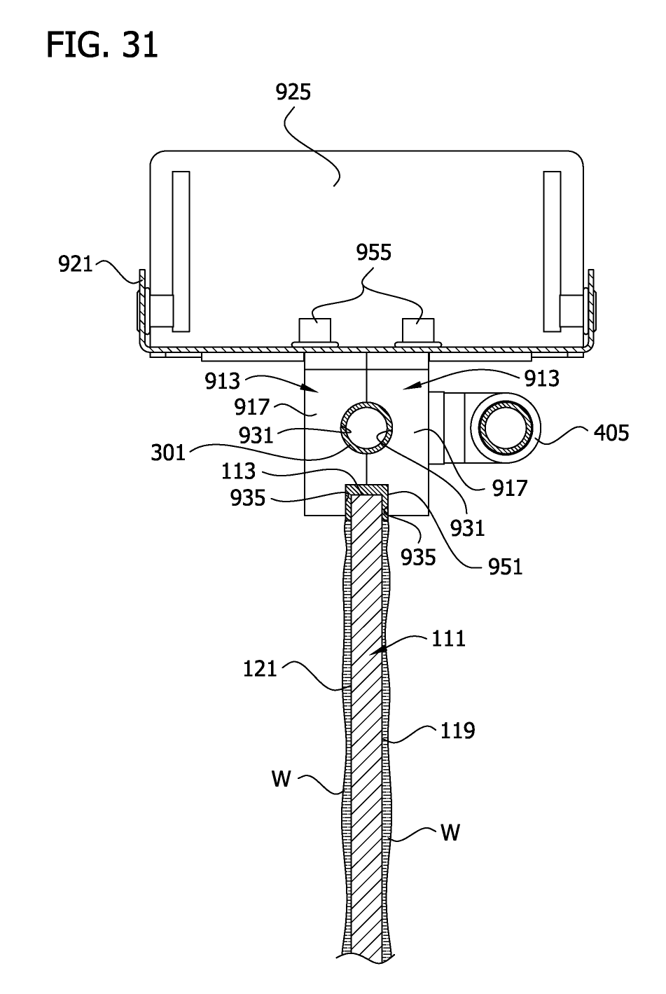

The top assembly 909 at the top of the display unit includes one or more pairs of brackets 913 (e.g., three bracket pairs) for holding the manifold 301 above the top of the panel 111. Each of the brackets 913 has a mounting plate 915 and a support plate 917 extending down from the mounting plate. The mounting plate 915 of each bracket is secured to a top plate 921 that extends between two of the studs 153 and is secured (e.g., by screws or other suitable fasteners) at each end to one leg 923 of an L-shaped bracket 925, which is screwed or otherwise secured to the sides of the studs 153. As illustrated, the support plate 917 of each bracket 913 has a semi-circular cutout 931 (FIG. 31) for receiving part of the manifold 301 (which is suitably made from a segment of pipe having a substantially circular cross sectional shape). The support plate 917 of each bracket 913 also includes a notched corner 935 at its lower end. The brackets 913 in each pair are suitably mirror images of one another and are positioned so their cutouts 931 and notched corners 935 face one another. When the brackets 913 are positioned adjacent one another their cutouts 931 form an opening for the manifold 301 and their notched corners form a notch for receiving the top 113 of the panel 111, as illustrated in FIG. 31.

The manifold 301 has a plurality of openings (not shown) distributed along the bottom of the manifold. For example, suitable openings can be made by drilling holes at intervals along the bottom of a plastic pipe that forms the manifold 301. Accordingly, when water flows from the manifold 301 it falls onto the top 113 of the panel 111. A rubber gasket 951 (FIG. 31) suitably extends along the top 113 of the panel 111 and extends a short distance down the front and back surfaces 119, 121 of the panel. The gasket 951 is suitably made of a material (e.g., EPDM rubber) that has very low surface tension. The gasket 951 helps guide water flowing from the manifold 301 into sheets of water flowing down the front and back surfaces 119, 121 of the panel 111. A wire mesh screen or metal cap (not shown) can be used instead of the 1013 gasket so the water from the manifold hits the screen first when it falls to the top of the panel from the manifold. The gasket 1013 (or screen if it is used) facilitates formation of sheets of water extending from the top of the panel 111 on both the front and back surfaces 119, 121 thereof.

The brackets 913 facilitate installation of the panel 111 in the display unit. For example, in a method of installing the panel, one of the brackets 913 in each pair is secured to the top plate 921 at various locations between the studs and the cutouts 931 of the brackets are adjacent the manifold 301 and all on the same side of the manifold. The panel 111 is placed in the display unit and positioned so the top 113 of the panel 111 is received in the notched corner 935 at the bottom of the bracket 913. Then the other bracket 913 for each pair is secured to the top plate so the panel 111 is retained in the notch formed by the notched corners 935 of the brackets, as illustrated in FIG. 31.

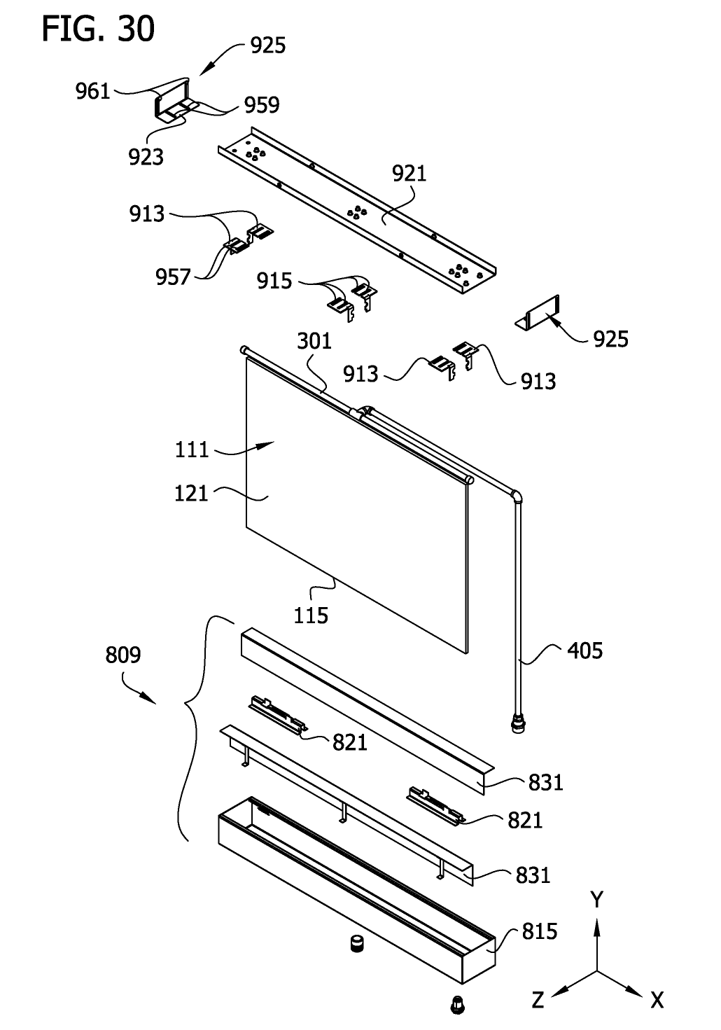

The brackets 913 are suitably secured to the top plate 921 by bolts 955 or other suitable fasteners (not shown) that extend into slots 957 (FIG. 30) in the mounting plates 915 extending generally perpendicularly to the front and back 121, 119 of the panel 111 when the panel is in the notch 1117. The slots 957 facilitate adjustments to the lateral positioning of the brackets 913 so they hold the top 113 of the panel 111 at a desired position in the wall 151. Also, the top plate 921 is suitably connected to the L-shaped brackets 925 by fasteners extending into slots 959 (FIG. 30) in the L-shaped brackets. The slots 959 are oriented generally parallel to the top 113 of the panel 111 when the panel is in the water display unit 905 and facilitate lateral adjustment to the position of the L-shaped bracket relative to the top plate 921. Similarly vertical slots 961 in the L-shaped bracket 925 facilitate vertical adjustment to the height at which the top assembly 909 is secured to the studs 153. Collectively, the various slots 957, 959, 961 provide a system for adjusting the position of the support plates 917 of the brackets 913 in each of the x, y, and z directions to facilitate positioning of the brackets at desired locations in the wall 151 regardless of variations that may be encountered in the construction of the wall.

When introducing elements of the present invention or the preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

1-10. (canceled)

11. A water display system comprising:
a body;
a reservoir for containing a supply of water;
a pump operable to pump water from the reservoir to the body in a manner that causes water to flow over a surface of the body, said water being in contact with a gas as it flows over the surface of the body; and
a humidity control system adapted to alter a humidity level of the gas by increasing a temperature of the water in the reservoir in response to a signal indicating the gas has a relatively lower humidity and decreasing the temperature of the water in the reservoir in response to a signal indicating the gas has a relatively higher humidity.

12. A water display system as set forth in claim 11 wherein the humidity control system comprises a heater adapted to increase the temperature of the water in the reservoir and a chiller adapted to decrease the temperature of the water in the reservoir.

13. A water display system as set forth in claim 11 wherein humidity control system further comprises: (i) a humidity sensor for monitoring the humidity level of the gas and generating said signals; and (ii) a control system adapted to automatically adjust the temperature of the water in the reservoir in response to the signals.

14. A water display system as set forth in claim 13 wherein the gas is in a building, the system further comprising a temperature sensor positioned to monitor a temperature exterior of the building.

15. A water display system as set forth in claim 11 wherein the humidity control system comprises:
a heater adapted to increase the temperature of the water in the reservoir; and
a control system adapted to activate the heater in response to said signal indicating the gas has a relatively lower humidity and to add water to the reservoir from an external source of water at a temperature that is lower than the temperature of the water in the reservoir in response to said signal indicating the gas has a relatively higher humidity.

16-24. (canceled)

25. A water display system comprising a body and a fluidic system operable to cause water to flow over a surface of the body, wherein the fluidic system comprises:
a reservoir for containing a supply of water;
a fluid circuit including at least one supply line for supplying water from the reservoir to the body and at least one return line for returning water from the body to the reservoir;
a pump operable to pump water from the reservoir through the through the fluid circuit to the body in a manner that causes the water to flow over said surface of the body; and
a cleaning system comprising a control system adapted to conduct at least two different cleaning protocols.

26. A water display system as set forth in claim 25 wherein:
one of said cleaning protocols comprises automatically:
(a) turning the pump off and returning substantially all the water in the fluid circuit to the reservoir;
(b) then heating the water in the reservoir to at least about 140 degrees F. to increase the volume of the water in the reservoir and kill microbes above a normal water level in the reservoir;
(c) draining the reservoir after the heating;
(d) filling the drained reservoir with a new supply of water; and
(e) then turning the pump back on.

27. A water display system as set forth in either of claims 25 and 26 wherein one of said cleaning protocols comprises automatically:
(i) draining a portion of the water supply from the reservoir;
(ii) adding water to the reservoir to replenish the supply of water in the reservoir; and
(iii) repeating the draining and adding at a frequency that achieves one hundred percent water exchange in a period of time ranging from about 1 hour to about 1 week.

28. A water display system as set forth in claim 25 wherein the control system is adapted to enable a user to enter an input to the control system to select a first mode in which the control system uses a first protocol and a second mode in which the control system uses a second protocol different from the first protocol.

29. A water display system as set forth in claim 25 wherein the control system is adapted to enable a user to enter an input to the control system to select a frequency for the repeating step of the second protocol.

30. A water display system as set forth in claim 27
wherein the cleaning system is operable to achieve said one hundred percent water exchange while the pump operates continuously for said period of time.

31. A water display system as set forth in claim 11 further comprising
a humidity sensor operable to monitor a humidity level of said gas and generate the signals indicative of the humidity level,
wherein the control system comprises a control panel operable to receive input from a user and display information about the water display system, the control system being adapted to receive said signals from the humidity sensor and increase the temperature of the water in the reservoir in response to a signal from the humidity sensor indicating the gas has a humidity lower than a minimum desired humidity and to decrease the temperature of the water in the reservoir in response to a signal from the humidity sensor indicating the gas has a humidity higher than a maximum desired humidity, the control system being adapted change at least one of the minimum desired humidity and the maximum desired humidity in response to an input received by the control panel from a user.

32. A water display system as set forth in claim 31 wherein the control panel has a housing and the control system comprises a circuit board inside the control panel housing, the humidity sensor being mounted on the circuit board.

33. A water display system as set forth in claim 32 wherein the control panel housing has one or more openings extending from an exterior of the housing to an interior of the housing.

34. A water display system as set forth in claim 33 wherein the humidity sensor is mounted on the circuit board adjacent one of the openings.

35. A water display system as set forth in claim 11 wherein the body comprises a panel having a top and a front surface extending down from the top and the system further comprises a housing holding the panel, the housing comprising a weir assembly having a channel for receiving the top of the panel, the channel being at least partially defined by a weir positioned to extend over an upper portion of the front surface of the panel when the top of the panel is in the channel, the weir assembly further comprising a trough adjacent the channel,
the pump being operable to pump water from the reservoir to the trough,
wherein the weir assembly is constructed so overflow from the trough flows over the top of the panel and down along the front surface of the panel.

36-40. (canceled)

41. An indoor air improvement system including a water display unit, the system comprising:
a body;
a reservoir for containing a supply of water;
a pump operable to pump water from the reservoir to the body in a manner that causes water to flow over at least a portion of the body;
a housing for holding the body; and
a fan positioned to direct air flow over said portion of the body.

42. An indoor air improvement system as set forth in claim 41 further comprising a humidity control system including a heater operable to selectively increase the temperature of water flowing over said portion of the body.

43. An indoor air improvement system as set forth in claim 41 wherein the body comprises a panel having a top, a bottom, sides extending between the top and bottom, and a front surface extending between the sides, the system further comprising a plenum on top of the housing, the fan being mounted in a space enclosed by the plenum and the top of the housing, the housing having a plurality of openings extending down from the space enclosed by the plenum and housing and positioned to direct airflow from the space generally toward the front surface of the panel.

44. An indoor air improvement system as set forth in claim 43 wherein the openings comprise elongate slots extending in a direction that is generally parallel to the top of the panel.

45-48. (canceled)
